(19) United States
(12) Patent Application Publication
(10) Pub. No.: US 2026/0164065 A1
(43) Pub. Date: Jun. 11, 2026

(54) METHOD, APPARATUS, AND MEDIUM FOR VIDEO PROCESSING

(71) Applicant: Bytedance Inc., Los Angeles, CA (US)

(72) Inventors: Yue LI, Los Angeles, CA (US); Kai Zhang, Los Angeles, CA (US); Li Zhang, Los Angeles, CA (US)

(21) Appl. No.: 19/181,015

(22) Filed: Apr. 16, 2025

Related U.S. Application Data
(63) Continuation of application No. PCT/US2023/077077, filed on Oct. 17, 2023.
(60) Provisional application No. 63/416,897, filed on Oct. 17, 2022.

(51) Int. Cl. H04N 19/70; H04N 19/176

(52) U.S. Cl. CPC H04N 19/70; H04N 19/176

(57) ABSTRACT

Embodiments of the present disclosure provide a solution for video processing. A method for video processing is proposed. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; and performing the conversion based on a result of the at least one coding operation.

### CROSS REFERENCE TO RELATED APPLICATIONS

This application is a continuation of International Application No. PCT/US2023/077077, filed on Oct. 17, 2023, which claims the benefit of U.S. Provisional Application No. 63/416,897, filed on Oct. 17, 2022. The entire contents of these applications are hereby incorporated by reference in their entireties.

### FIELDS

Embodiments of the present disclosure relates generally to video processing techniques, and more particularly, to neural network-based video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for neural network-based video coding.

In a first aspect, a method for video processing is proposed. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; and performing the conversion based on a result of the at least one coding operation. The method in accordance with the first aspect of the present disclosure can make full and efficient use of information from previously coded frames to filter the current frame, thereby improving the coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; and generating a bitstream of the video based on a result of the at least one coding operation.

In a fifth aspect, a method for storing a bitstream of a video is proposed. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; generating a bitstream of the video based on a result of the at least one coding operation; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles, bricks, and rectangular slices;

FIG. 7A illustrates a schematic diagram of coding tree blocks (CTBs) crossing the bottom picture border;

FIG. 7B illustrates a schematic diagram of CTBs crossing the right picture border;

FIG. 7C illustrates a schematic diagram of CTBs crossing the right bottom picture border;

FIG. 8 illustrates an example of encoder block diagram of VVC;

FIG. 9 illustrates a schematic diagram of picture samples and horizontal and vertical block boundaries on the 8×8 grid, and the nonoverlapping blocks of the 8×8 samples, which can be deblocked in parallel;

FIG. 10 illustrates a schematic diagram of pixels involved in filter on/off decision and strong/weak filter selection;

FIG. 11A illustrates an example of 1-D directional pattern for EO sample classification which is a horizontal pattern with EO class=0;

FIG. 11B illustrates an example of 1-D directional pattern for EO sample classification which is a vertical pattern with EO class=1;

FIG. 11C illustrates an example of 1-D directional pattern for EO sample classification which is a 135° diagonal pattern with EO class=2;

FIG. 11D illustrates an example of 1-D directional pattern for EO sample classification which is a 450 diagonal pattern with EO class=3;

FIG. 12A illustrates an example of a geometry transformation-based adaptive loop filter (GALF) filter shape of 5×5 diamond;

FIG. 12B illustrates an example of a GALF filter shape of 7×7 diamond;

FIG. 12C illustrates an example of a GALF filter shape of 9×9 diamond;

FIG. 13A illustrates an example of relative coordinator for the 5×5 diamond filter support in case of diagonal;

FIG. 13B illustrates an example of relative coordinator for the 5×5 diamond filter support in case of vertical flip;

FIG. 13C illustrates an example of relative coordinator for the 5×5 diamond filter support in case of rotation;

FIG. 14 illustrates an example of relative coordinates used for 5×5 diamond filter support;

FIG. 15A illustrates a schematic diagram of an architecture of the proposed convolutional neural network (CNN) filter where M denotes the number of feature maps and N stands for the number of samples in one dimension;

FIG. 15B illustrates an example of the construction of residual block (ResBlock) in the CNN filter of FIG. 15A;

FIGS. 16A-16B illustrate schematic diagrams of a raster scan order and a Z scan order respectively, where the solid and dash blue lines represent the CTU boundary and inference block boundary respectively;

FIG. 17 illustrates a flowchart of a method for video processing in accordance with embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

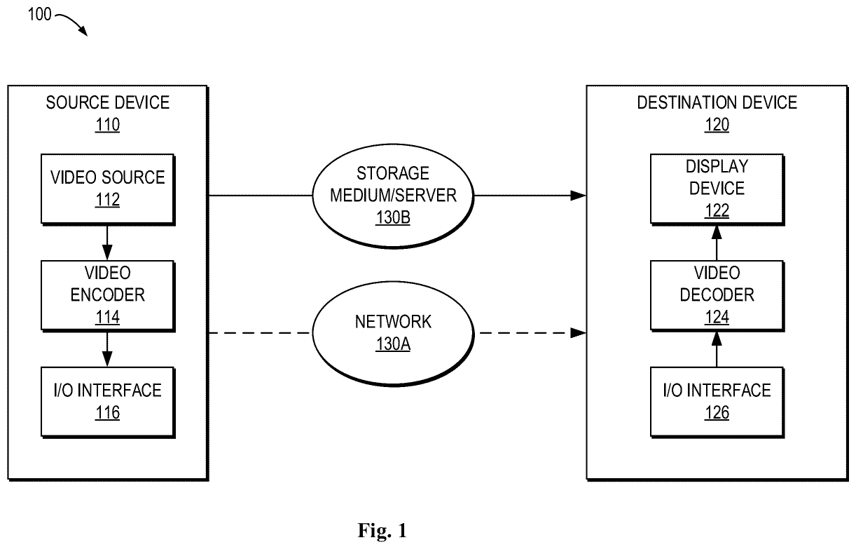

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user.

The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

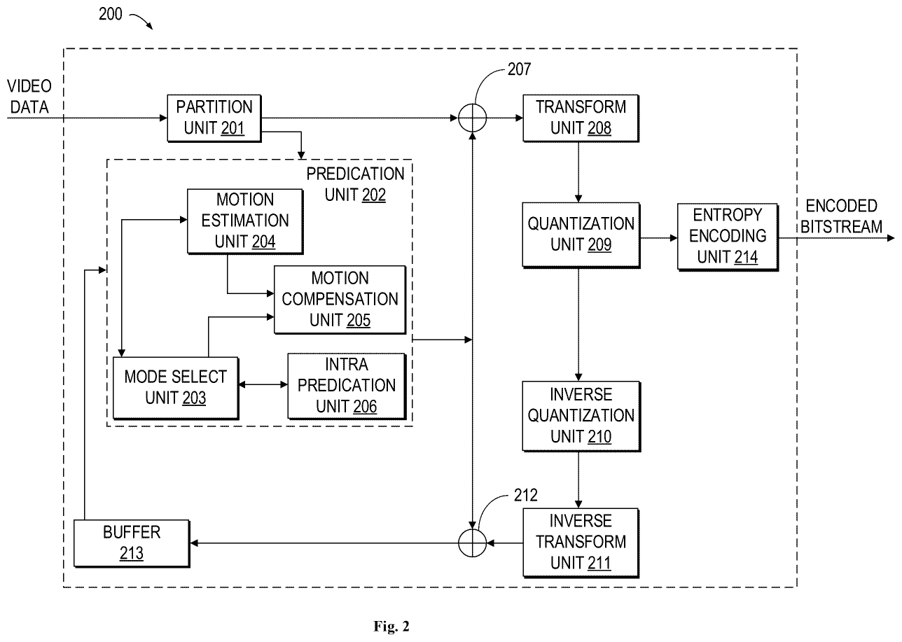

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

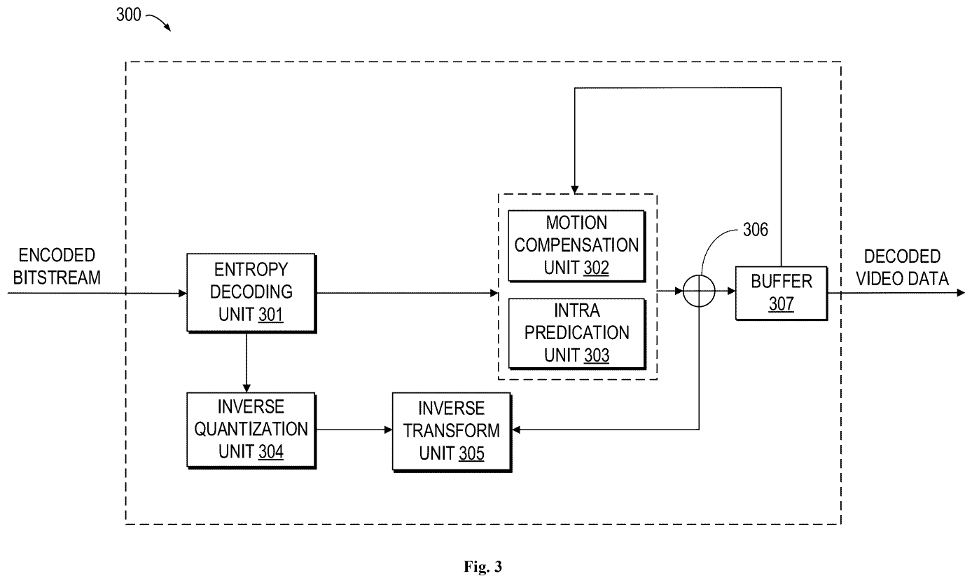

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

The detailed description is related to video coding technologies. Specifically, it is related to the loop filter in image/video coding. It may be applied to the existing video coding standard like High-Efficiency Video Coding (HEVC), Versatile Video Coding (VVC), or AVS3. It may be also applicable to future video coding standards or video codec or being used as post-processing method which is out of encoding/decoding process.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

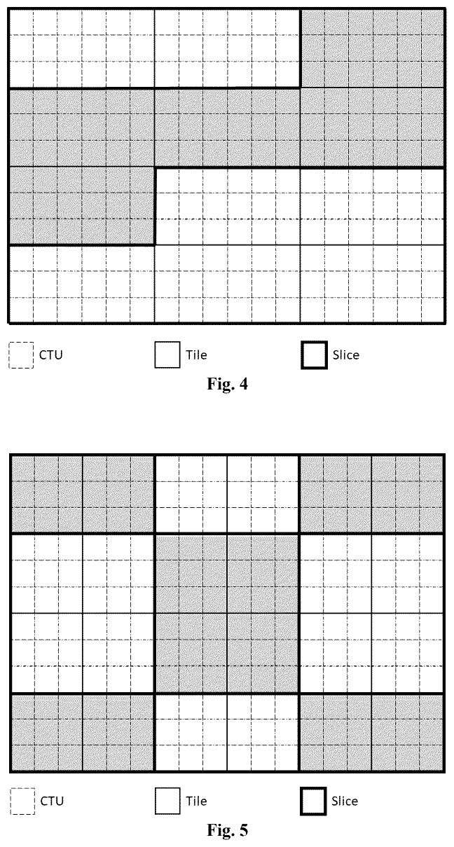

FIG. 4 shows an example of raster-scan slice partitioning of a picture, where the picture is divided into 12 tiles and 3 raster-scan slices. In this figure, a picture with 18 by 12 luma CTUs is partitioned into 12 tiles and 3 raster-scan slices (informative).

FIG. 5 in the VVC specification shows an example of rectangular slice partitioning of a picture, where the picture is divided into 24 tiles (6 tile columns and 4 tile rows) and 9 rectangular slices. In this figure, a picture with 18 by 12 luma CTUs is partitioned into 24 tiles and 9 rectangular slices (informative).

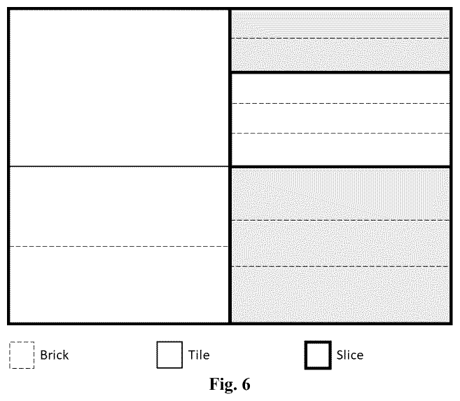

FIG. 6 in the VVC specification shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. In this figure, a picture that is partitioned into 4 tiles, 11 bricks, and 4 rectangular slices (informative).

### 2.2.1. CTU/CTB Sizes

In VVC, the CTU size, signaled in SPS by the syntax element log 2_ctusize_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size.

The variables CtbLog 2SizeY, CtbSizeY, MinCbLog 2SizeY, MinCbSizeY, MinTbLog 2SizeY, MaxTbLog 2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$CtbLog 2 SizeY = log 2 \_ctu \_size \_minus2 + 2 \qquad ( 7 - 9 )$$

$$CtbSizeY = 1 << CtbLog 2 SizeY \qquad ( 7 - 10 )$$

$$( 7 - 11 )$$

$$MinCbLog 2 SizeY = log2\_min \_luma \_coding \_block \_size \_minus2 + 2$$

$$MinCbSizeY = 1 << MinCbLog 2 SizeY \qquad ( 7 - 12 )$$

$$MinTbLog 2 SizeY = 2 \qquad ( 7 - 13 )$$

$$MaxTbLog 2 SizeY = 6 \qquad ( 7 - 14 )$$

$$MinTbSizeY = 1 << MinTbLog 2 SizeY \qquad ( 7 - 15 )$$

$$MaxTbSizeY = 1 << MaxTbLog 2 SizeY \qquad ( 7 - 16 )$$

$$PicWidthInCtbsY = Ceil ( pic\_ width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthInMinCbsY = pic\_ width \_in \_luma \_samples / MinCbSizeY \qquad ( 7 - 20 )$$

$$PicHeightInMinCbsY = pic\_height \_in \_luma \_samples / MinCbSizeY \qquad ( 7 - 21 )$$

$$PicSizeInMinCbsY = PicWidthInMinCbsY * PicHeightInMinCbsY \qquad ( 7 - 22 )$$

$$PicSizeInSamplesY = pic\_ width \_in \_luma \_samples / pic\_height \_in \_luma \_samples \qquad ( 7 - 23 )$$

$$PicWidthInSamplesC = pic\_ width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 2.2.2. CTUs in a Picture

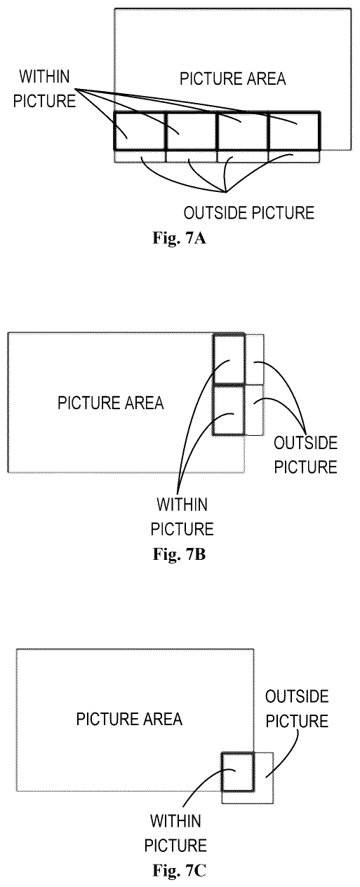

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 7A, 7B, and 7C, the CTB size is still equal to M×N, however, the bottom boundary/right boundary of the CTB is outside the picture.

FIGS. 7A, 7B, and 7C shows examples of CTBs crossing picture borders. FIG. 7A shows CTBs crossing the bottom picture border, where K=M, L<N. FIG. 7B shows CTBs crossing the right picture border, where K<M, L=N. FIG. 7C shows CTBs crossing the right bottom picture border where K<M, L<N.

### 2.3. Coding Flow of a Typical Video Codec

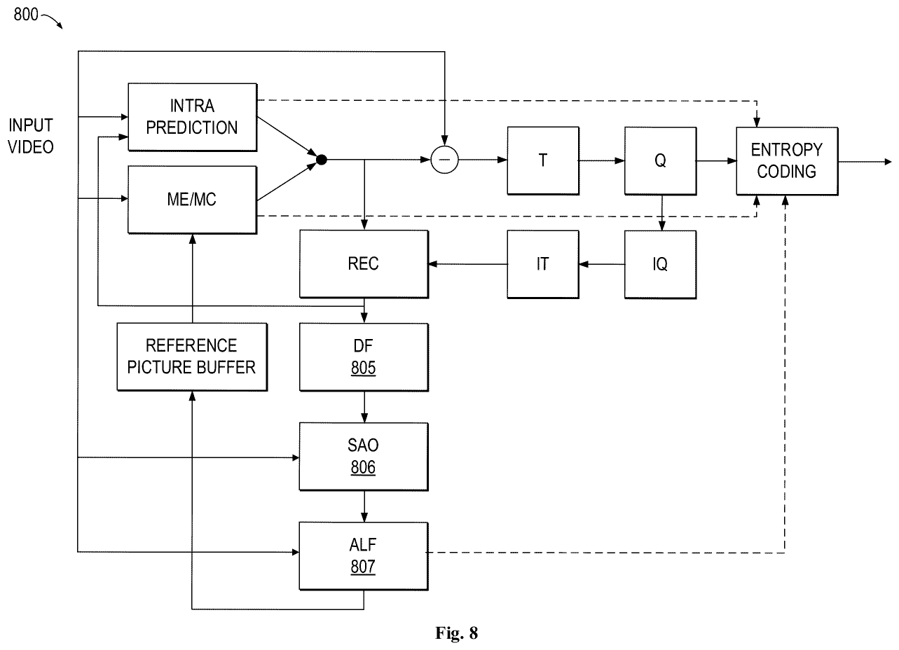

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages. FIG. 8 shows an example 800 of encoder block diagram.

### 2.4. Deblocking Filter (DB)

The Input of DB is the Reconstructed Samples Before in-Loop Filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

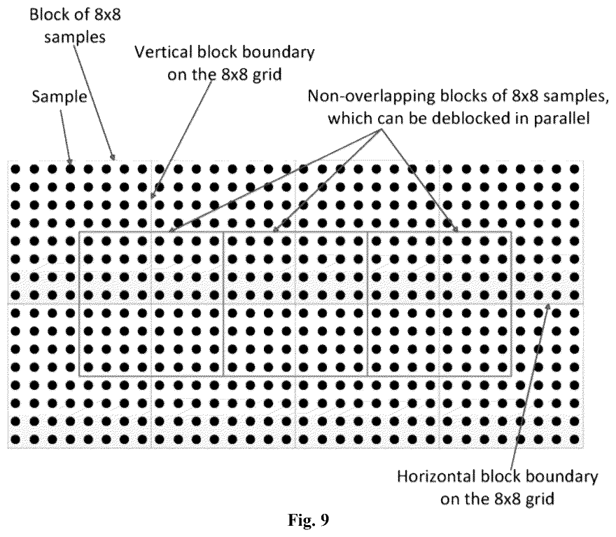

FIG. 9 provides illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS[xDᵢ][yDⱼ](wherein [xDᵢ][yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks has non-zero transform | 1 | 1 | 1 |
| | coefficients | | | |
| 3 | Reference pictures or number of MVs (1 for uni-prediction, 2 for bi- | 1 | N/A | N/A |
| | prediction) of the adjacent blocks are different | | | |
| 2 | Absolute difference between the motion vectors of same reference picture | 1 | N/A | N/A |
| | that belong to the adjacent blocks is greater than or equal to one integer | | | |
| | luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent blocks has non-zero transform | 1 | 1 | 1 |
| | coefficients | | | |
| 6 | Prediction mode of adjacent blocks is different (e.g., one is IBC, one is | 1 | | |
| | inter) | | | |
| 5 | Both IBC and absolute difference between the motion vectors that belong | 1 | N/A | N/A |
| | to the adjacent blocks is greater than or equal to one integer luma sample | | | |
| 4 | Reference pictures or number of MVs (1 for uni-prediction, 2 for bi- | 1 | N/A | N/A |
| | prediction) of the adjacent blocks are different | | | |
| 3 | Absolute difference between the motion vectors of same reference picture | 1 | N/A | N/A |
| | that belong to the adjacent blocks is greater than or equal to one integer | | | |
| | luma sample | | | |
| 1 | Otherwise | 0 | 0 | 0 |

### 2.4.3. Deblocking Decision for Luma Component

The deblocking decision process is described in this sub-section.

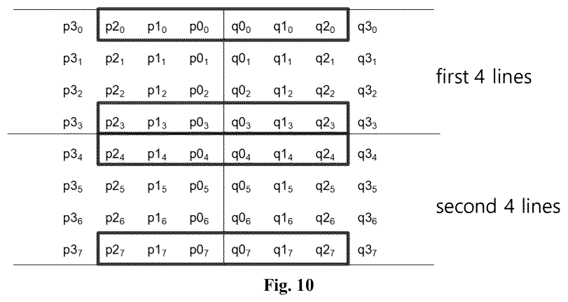

FIG. 10 shows pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

$$bSidePisLargeBlk = ( ( edge type is vertical and {p}_{0} belongs to CU with width >= 32 ) \vert \vert ( edge type is horizontal and {p}_{0} belongs to CU with height >= 32 ) ? TRUE \text{} \text{:} FALSE$$

Based on bSidePisLargeBlk and bSideQisLargeBlk, the condition 1 is defined as follows.

$$( bSidePisLargeBlk ‖ bSidePisLargeBlk ) ? TRUE \text{:} FALSE \qquad Condition 1$$

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( p {5}_{0} - 2 * p {4}_{0} + p {3}_{0} ) + 1 ) >> 1$$

$$dp 3 = ( dp 3 + Abs ( p {5}_{3} - 2 * p {4}_{3} + p {3}_{3} ) + 1 ) >> 1$$

if (q side is greater than or equal to 32)

$$dq 0 = ( dq 0 + Abs ( q {5}_{0} - 2 * q {4}_{0} + q {3}_{0} ) + 1 ) >> 1$$

$$dq 3 = ( dq 3 + Abs ( q {5}_{3} - 2 * q {4}_{3} + q {3}_{3} ) + 1 ) >> 1$$

Condition2=(d<β)?TRUE:FALSE

$$where d = dp 0 + dq 0 + dp 3 + dq 3.$$

If Condition1 and Condition2 are valid, whether any of the blocks uses sub-blocks is further checked:

```
If (bSidePisLargeBlk)
  {
      If (mode block P == SUBBLOCKMODE)
          Sp =5
      else
          Sp =7
}
else
  Sp = 3
If (bSideQisLargeBlk)
    {
      If (mode block Q == SUBBLOCKMODE)
            Sq =5
        else
        Sq =7
    }
else
    Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
  dpq is derived as in HEVC.
  sp₃ = Abs( p₃ − p₀ ), derived as in HEVC
  if (p side is greater than or equal to 32)
      if(Sp==5)
        sp₃ = ( sp₃ + Abs( p₅ − p₃ ) + 1) >> 1
      else
        sp₃ = ( sp₃ + Abs( p₇ − p₃ ) + 1) >> 1
  sq₃ = Abs( q₀ − q₃ ), derived as in HEVC
  if (q side is greater than or equal to 32)
    If(Sq==5)
      sq₃ = ( sq₃ + Abs( q₅ − q₃ ) + 1) >> 1
    else
      sq₃ = ( sq₃ + Abs( q₇ − q₃ ) + 1) >> 1
```

As in HEVC, StrongFilterCondition=(dpq is less than (β>>2), sp₃+sq₃ is less than (3*β>>5), and Abs(p₀−q₀) is less than (5*t_{C}+1)>>1)?TRUE:FALSE.

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp−1 and qᵢ for j=0 to Sq−1 (pi and qi are the i-th sample within a row for filtering vertical edge, or the i-th sample within a column for filtering horizontal edge) in HEVC deblocking described above) are then replaced by linear interpolation as follows:

$$- {p}_{i}^{′} = ( {f}_{i} * {Middle}_{s , t} + ( 64 - {f}_{i} ) * {P}_{s} + 32 ) >> 6 ) , clipped to {p}_{i} \pm {tcPD}_{i}$$

$$- {q}_{j}^{′} = ( {g}_{j} * {Middle}_{s , t} + ( 64 - {g}_{j} ) * {Q}_{s} + 32 ) >> 6 ) , clipped to {q}_{j} \pm {tcPD}_{j}$$

where tcPDᵢ and tcPDⱼ term is a position dependent clipping described in Section 2.4.7 and gⱼ, fᵢ, Middle_{s,t}, Pₛ and Qₛ are given below.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.
The second condition will be TRUE when d is less than β.

In the third condition StrongFilterCondition is derived as follows:
dpq is derived as in HEVC.

$${sp}_{3} = Abs ( {p}_{3} - {p}_{0} ) , derived as in HEVC$$

$${sq}_{3} = Abs ( {q}_{0} - {q}_{3} ) , derived as in HEVC$$

As in HEVC design, StrongFilterCondition=(dpq is less than (β>>2), sp₃+sq₃ is less than (β>>3), and Abs(p₀−q₀) is less than (5*t_{C}+1)>>1).

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) >> 3$$

$${p}_{1}^{′} = ( 2 * {p}_{3} + {p}_{2} + 2 * {p}_{1} + {p}_{0} + {q}_{0} + {q}_{1} + 4 ) >> 3$$

$${p}_{0}^{′} = ( {p}_{3} + {p}_{2} + {p}_{1} + 2 * {p}_{0} + {q}_{0} + {q}_{1} + {q}_{2} + 4 ) >> 3$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ;$$

$$Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7 ;$$

For the P or Q boundaries being filtered with a short symmetrical filter, position dependent threshold of lower magnitude is applied:

$$Tc 3 = \{ 3 , 2 , 1 \} ;$$

Following defining the threshold, filtered p′ᵢ and q′ᵢ sample values are clipped according to tcP and tcQ clipping values:

$${p}_{i}^{′′} = Clip 3 ( {p}_{i}^{′} + {tcP}_{i} , {p}_{i}^{′} - {tcP}_{i} , {p}_{i}^{′} ) ;$$

$${q}_{j}^{′′} = Clip 3 ( {q}_{j}^{′} + {tcQ}_{j} , {q}_{j}^{′} - {tcQ}_{j} , {q}_{j}^{′} ) ;$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength - 2) ∥ edge == (56 / 4) ∥
    edge == (72 / 4))
      Sp = Sq = 2;
    else
      Sp = Sq = 3;
  else
    Sp = Sq = bSideQisLargeBlk ? 5:3
}
```

Where edge equal to 0 corresponds to CU boundary, edge equal to 2 or equal to orthogonalLength−2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

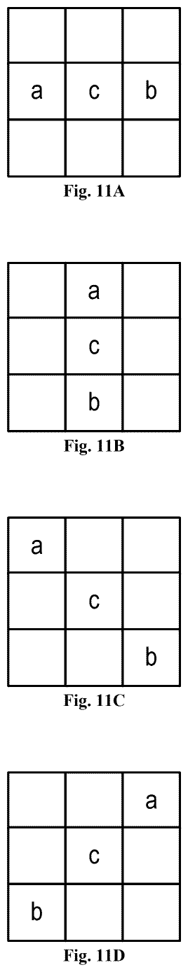

FIGS. 11A to 11D shows four 1-D directional patterns for EO sample classification: horizontal (EO class=0), vertical (EO class=1), 135° diagonal (EO class=2), and 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) \|\|(c == a && c < b) |
| 3 | (c > a && c == b) \|\|(c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption [3] is applied. For the luma component, one among 25 filters is selected for each 2×2 block, based on the direction and activity of local gradients.

### 2.6.1. Filter Shape

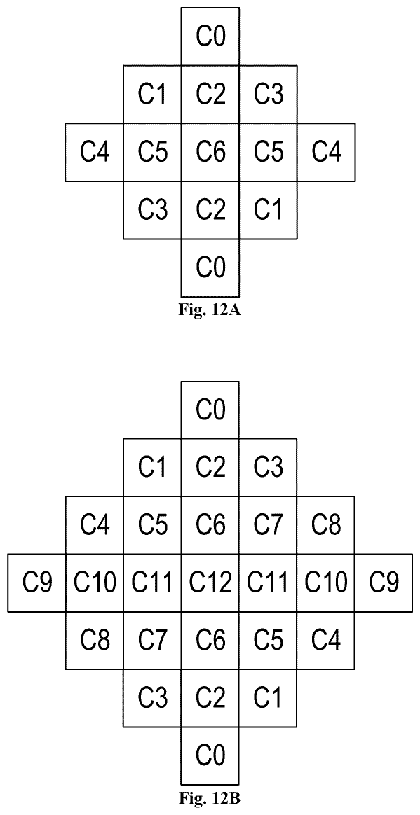

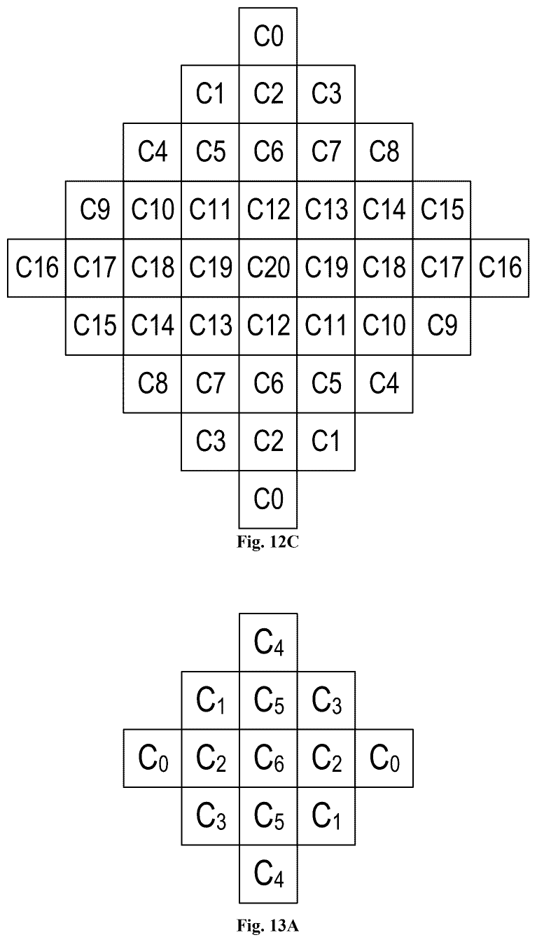

In the JEM, up to three diamond filter shapes (as shown in FIGS. 12A-12C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used.

FIGS. 12A-12C show GALF filter shapes (left: 5×5 diamond, middle: 7×7 diamond, right: 9×9 diamond).

### 2.6.1.1. Block Classification

Each 2×2 block is categorized into one out of 25 classes. The classification index C is derived based on its directionality D and a quantized value of activity Â, as follows:

$$C = 5 D + \hat{A} . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$$( 4 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$$( 5 )$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i, j) indicates a reconstructed sample at coordinate (i, j).

Then D maximum and minimum values of the gradients of horizontal and vertical directions are set as:

$${g}_{h , ν}^{max} = max ( {g}_{h} , {g}_{ν} ) , {g}_{h , ν}^{min} = min ( {g}_{h} , {g}_{ν} ) , \qquad ( 6 )$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) , \qquad ( 7 )$$

To derive the value of the directionality D, these values are compared against each other and with two thresholds t₁ and t₂:

Step 1. If both

$${g}_{h , ν}^{max} \leq {t}_{1} \cdot {g}_{h , v}^{min} > {g}_{d 0 , d 1}^{max} \leq {t}_{1} \cdot {g}_{d 0 , d 1}^{min}$$

are true, D is set to 0.

Step 2. If

$${g}_{h , ν}^{max} / {g}_{h , ν}^{min} > {g}_{d 0 , d 1}^{max} / {g}_{d 0 , d 1}^{min} ,$$

continue from Step 3; otherwise continue from Step 4.

Step 3. If

$${g}_{h , ν}^{max} > {t}_{2} \cdot {g}_{h , ν}^{min} , D$$

is set to 2; otherwise D is set to 1.

Step 4. If

$${g}_{d 0 , d 1}^{max} > {t}_{2} \cdot {g}_{d 0 , d 1}^{min} , D$$

is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

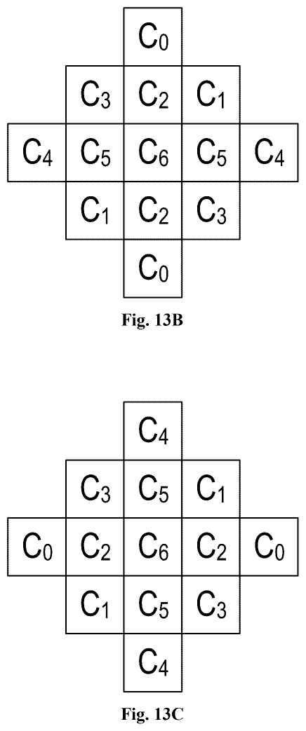

FIG. 13A shows relative coordinator for the 5×5 diamond filter support in case of diagonal. FIG. 13B shows relative coordinator for the 5×5 diamond filter support in case of vertical flip. FIG. 13C shows relative coordinator for the 5×5 diamond filter support in case of rotation.

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , \qquad ( 9 )$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) depending on gradient values calculated for that block. The relationship between the transformation and the four gradients of the four directions are summarized in Table 4. FIGS. 13A-13C show the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f(k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i, j) within the block is filtered, resulting in sample value R′(i, j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

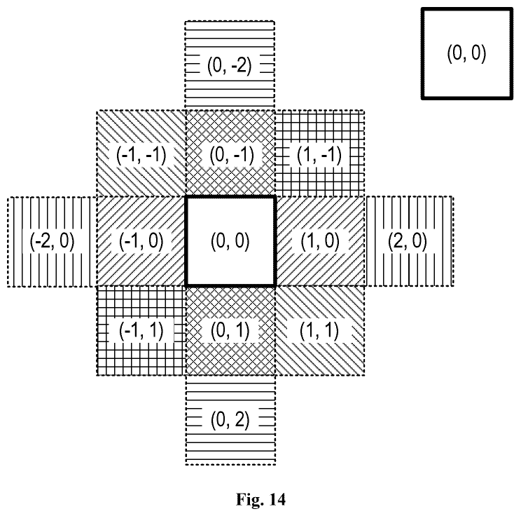

FIG. 14 shows an example of relative coordinates used for 5×5 diamond filter support supposing the current sample's coordinate (i, j) to be (0, 0). Samples in different coordinates filled with the same color are multiplied with the same filter coefficients. In FIG. 14. examples of relative coordinates for the 5×5 diamond filter support are provided.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(x+i, y+j) are input samples, O(x, y) is the filtered output sample (i.e. filter result), and w(i, j) denotes the filter coefficients. In practice, in VTM4.0 it is implemented using integer arithmetic for fixed point precision computations:

$$O ( x , y ) = ( \begin{matrix}{\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64\end{matrix} ) >> 7 , \qquad ( 12 )$$

where L denotes the filter length, and where w(i, j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, as proposed in JVET-L0147, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) ) , \qquad ( 13 )$$

where w(i, j) are the same filter coefficients as in equation (11) [excepted w(0, 0) which is equal to 1 in equation (13) while it is equal to 1−Σ_{(i,j)≠(0,0)}w(i, j) in equation (11)].

Using this above filter formula of (13), VVC introduces the non-linearity to make ALF more efficient by using a simple clipping function to reduce the impact of neighbor sample values (I(x+i, y+j)) when they are too different with the current sample value (I(x, y)) being filtered.

More specifically, the ALF filter is modified as follows:

$$O ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K(d, b)=min(b, max(−b, d)) is the clipping function, and k(i, j) are clipping parameters, which depends on the (i, j) filter coefficient. The encoder performs the optimization to find the best k(i, j).

In the JVET-N0242 implementation, the clipping parameters k(i, j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values used in the JVET-N0242 tests are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} , with M = {2}^{10} and N = 4. \qquad ( 15 )$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 … N ] \} , with M = {2}^{10} , N = 4 and A = 4. \qquad ( 16 )$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may not be satisfactory. Therefore, works distributed in the second type take neural networks as an auxiliary, and enhance traditional compression frameworks by replacing or enhancing some modules. In this way, they can inherit the merits of the highly optimized traditional frameworks. For example, Li et al. propose a fully connected network for the intra prediction in HEVC. In addition to intra prediction, deep learning is also exploited to enhance other modules. For example, Dai et al. replace the in-loop filters of HEVC with a convolutional neural network and achieve promising results. The work applies neural networks to improve the arithmetic coding engine.

2.9.3. Convolutional Neural Network Based in-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias.

First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

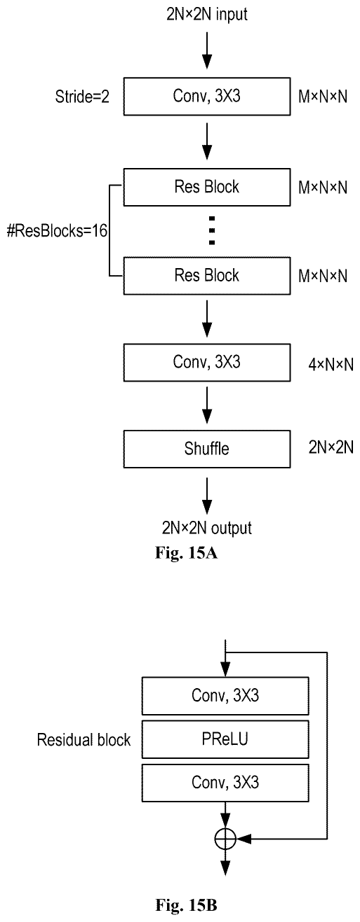

FIG. 15A shows an architecture of the proposed CNN filter. M denotes the number of feature maps. N stands for the number of samples in one dimension. FIG. 15B shows construction of ResBlock (residual block) in FIG. 15A.

In most of deep convolutional neural networks, residual blocks are utilized as the basic module and stacked several times to construct the final network wherein in one example, the residual block is obtained by combining a convolutional layer, a ReLU/PReLU activation function and a convolutional layer as shown in FIG. 15B.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. PROBLEMS

The current NN-based in-loop filtering has the following problems:
1. The network does not make fully use of information from previously coded frames to filter the current frame. For example, temporal prediction has been used as additional input. However, there are other valuable information that can be potentially exploited, such as collocated reference blocks from list 0 and/or list 1.
2. When the information from multiple previously coded frames is exploited, the mechanism to use them is not efficient enough. For example, when large motion occurs between current frame and previously coded frames, it might reduce the filtering performance if simply taking a collocated block from a previously coded frame as an additional input.

### 4. INVENTION

The detailed inventions below should be considered as examples to explain general concepts. These inventions should not be interpreted in a narrow way. Furthermore, these inventions can be combined in any manner.

One or more neural network (NN) filter models are trained as part of an in-loop filtering technology or filtering technology used in a post-processing stage for reducing the distortion incurred during compression. Samples with different characteristics are processed by different NN filter models. The NN filter models might take information from one/multiple previously coded frames as additional input. This invention elaborates how to use information from previously coded frames, which information to use from previously coded frames, and when to use information from previously coded frames.

In the disclosure, a NN filter can be any kind of NN filter, such as a convolutional neural network (CNN) filter. In the following discussion, a NN filter may also be referred to as a non-CNN filter, e.g., filter using machine learning based solutions.

In the following discussion, a block may be a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick, an inference block. In some cases, the block could be one or multiple samples/pixels.

In the following discussion, a NN filter comprises a model/structure (i.e. network topology) and parameters associated with the model/structure.

In the following discussion, besides the additional information from reference frames, the NN filter models may take other information as input to filter the current block as well. For example, those other information could be the prediction information of current block, partitioning information of current block, boundary strengths information of current block, coding modes information of current block, etc.

### On the Multiple Reference Frames-Based Filtering

1. NN filter may take information from one/multiple previously coded frames as additional inputs when filtering a block in the current slice/frame.
   a. In one example, the previously coded frame may be a reference frame in a reference picture list (RPL) or reference picture set (RPS) associated with the block/the current slice/frame.
      i. In one example, the previously coded frame may be a short-term reference picture of the block/the current slice/frame.
      ii. In one example, the previously coded frame may be long-term reference picture of the block/the current slice/frame.
   b. Alternatively, the previously coded frame may NOT be a reference frame, but it is stored in the decoded picture buffer (DPB).
   c. In one example, at least one indicator is signalled to indicate which previously coded frame(s) to use.
      i. In one example, one indicator is signalled to indicate which reference picture list to use.
      ii. Alternatively, the indicator may be conditionally signalled, e.g., depending on how many reference pictures are included in the RPL/RPS.
      iii. Alternatively, the indicator may be conditionally signalled, e.g., depending on how many previously decoded pictures are included in the DPB.
   d. In one example, which frames to be utilized is determined on-the-fly.
      i. In one example, NN filter may take information from one/multiple previously coded frames in DPB as additional input.
      ii. In one example, NN filter may take information from one/multiple reference frames in list 0 as additional input.
      iii. In one example, NN filter may take information from one/multiple reference frames in list 1 as addition input.
      iv. In one example, NN filter may take information from reference frames in both list 0 and list 1 as additional input.
      v. In one example, NN filter may take information from the refence frame closest (e.g., with smallest POC distance to current slice/frame) to the current frame as additional input.
      vi. In one example, NN filter may take information from the refence frame with reference index equal to K (e.g., K=0) in a reference list.
         1) In one example, K may be pre-defined.
         2) In one example, K may be derived on-the-fly according to reference picture information.
      vii. In one example, NN filter may take information from the collocated frame as additional input.
      viii. In one example, which frame to be utilized may be determined by the decoded information.
         1) In one example, which frame to be utilized may be defined as the top N (e.g., N=1) most-frequently used reference pictures for samples within the current slice/frame.
         2) In one example, which frame to be utilized may be defined as the top N (e.g., N=1) most-frequently used reference pictures of each reference picture list, if available, for samples within the current slice/frame.
         3) In one example, which frame to be utilized may be defined as the pictures with top N (e.g., N=1) smallest POC distances/absolute POC distances relative to current picture.
   e. In one example, whether to take information from previously coded frames as additional input may be dependent on decoded information (e.g., coding modes/statistics/characteristics) of at least one region of the to-be-filtered block.
      i. In one example, whether to take information from previously coded frames as additional input may be dependent on the slice/picture type.
         1) In one example, it may be only applicable to inter-coded slices/pictures (e.g., P or B slices/pictures).
         2) In one example, whether to take information from previously coded frames as additional input may be dependent on availability of reference pictures.
      ii. In one example, whether to take information from previously coded frames as additional input may be dependent on the reference picture information or the picture information in the DPB.
         1) In one example, if the smallest POC distance (e.g., smallest POC distance between reference pictures/pictures in DPB and current picture) is greater than a threshold, it is disabled.
         2) In one example, whether to and/or how to apply the proposed method may depend on the POCs of the reference frames and that of the current frames.
         a. In one example, it is enabled only when there are at least one reference picture/picture in DPB with POC greater than the POC of current picture and at least one reference picture/picture in DPB with POC smaller than the POC of current picture.
         i. Alternatively, the proposed method may be conducted in different ways when the condition is satisfied or not satisfied. The condition is there are at least one reference picture/picture in DPB with POC greater than the POC of current picture and at least one reference picture/picture in DPB with POC smaller than the POC of current picture.
         3) In one example, if the reference picture is list 0 and the reference picture in list 1 are the same picture, it is disabled.
         4) In one example, if the reference picture in list 0 or list 1 does not exist, it is disabled.
      iii. In one example, whether to take information from previously coded frames as additional input may be dependent on the temporal layer index.
         1) In one example, it may be applicable to blocks with a given temporal layer index (e.g., the highest temporal layer).
      iv. In one example, if the to-be-filtered block contains a portion of samples that are coded in non-inter mode, NN filter will not use information from previously coded frames to filter the block.
         1) In one example, the non-inter mode may be defined as intra mode.
         2) In one example, the non-inter mode may be defined as a set of coding mode which includes intra/IBC/Palette modes.
      v. In one example, a distortion between current block and the matching block is calculated and used to decide whether to take information from previously coded frames as additional input to filter current block.
         1) Alternatively, the distortion between the collocated block in a previously coded frame and current block can be used to decide whether to take information from previously coded frames as additional input to filter current block.
         2) In one example, motion estimation is first used to find a matching block from at least one previously coded frame.
         3) In one example, when the distortion is larger than a pre-defined threshold, information from previously coded frames will not be used.
            On the Information from Previously Coded Frames
2. To help filter current block, NN filter model may use additional information from previously coded frames. The information may contain reconstruction samples/motion information in the previously coded frames.
   a. In one example, reconstruction samples may be defined as those in the one/multiple reference blocks and/or collocated blocks of current block.
   b. In one example, reconstruction samples may be defined as those in a region pointed by a motion vector.
      i. In one example, the motion vector may be different from the decoded motion vector associated with current block.
   c. In one example, a collocated block may refer to a block whose center is located at the same horizontal and vertical position in a previously coded frame as that of current block in the current frame.
   d. In one example, a reference block is derived by motion estimation, i.e. searching from a previously coded frame to find the block that is closest to current block with a certain measure.
      i. In one example, the motion estimation is performed at integer precision to avoid fractional pixel interpolation.
   e. In one example, a reference block is derived by reusing at least one motion vector contained in the current block.
      i. In one example, the motion vector is first rounded to the integer precision to avoid fractional pixel interpolation.
      ii. In one example, the reference block is located by adding an offset which is determined by the motion vector to the position of the current block.
      iii. In one example, the motion vector should refer to the previously coded picture containing the reference block.
      iv. In one example, the motion vector may be scaled to the previously coded picture containing the reference block.
   f. In one example, reference blocks and/or collocated blocks are the same size of current block.
   g. In one example, reference blocks and/or collocated blocks could be larger than current block.
      i. In one example, reference blocks and/or collocated blocks with the same size of current block are first found and then extended at each boundary to contain more samples from previously coded samples.
         1) In one example, the size of extended area could be signalled to the decoder or derived on-the-fly.
   h. In one example, the information contains two reference blocks and/or collocated blocks of current block, with one of them from the first reference frame in list-0 and the other from the first reference frame in list-1.
      On how to Feed the Information from Previously Coded Frames into NN Filter Models
3. To help filter the current block, additional information from previously coded frames is fed as input of NN filter models. The additional information such as reference blocks, collocated blocks, etc. may be fed together or separately with other information such as prediction, partitioning information, etc.
   a. In one example, different kinds of information should be organized with the same size (such as the width and/or height of the 2D data) and thus are concatenated together to be fed into the NN filter models.
   b. In one example, a separate convolutional branch may first extract features from the additional information such as one/multiple reference blocks and/or collocated blocks of current block in the previously coded frames. Those extracted features may be then fused together with other input information or fused together with the features extracted from other input information.
      i. In one example, the reference blocks and/or collocated blocks of current block in the previously coded frames may be with different size to (e.g. larger than) other input information such as prediction, partitioning etc.
         1) In one example, a separate convolutional branch is used to extract features that have the same spatial dimension as other input information.
   c. In one example, current block together with the reference blocks and/or collocated blocks are fed together into a motion alignment branch. The output of the motion alignment branch is then fused together other information.

### On Other NN-Based Tools

4. The above methods may be applied to other coding technologies using NNs, e.g., super-resolution, inter prediction, virtual reference frame generation, etc.
   a. In one example, a NN model is used to super-resolve a block in a inter slice. The NN model may take information from one/multiple previously coded frames as additional input.
5. Whether to/how to apply the proposed method may be signaled from the encoder to the decoder such as in SPS/PPS/APS/slice header/picture header/CTU/CU, etc.
6. Whether to/how to apply the proposed method may depend on coding information such as color component, QP, temporal layer etc.
   a. For example, the proposed method may only be applied on a luma component, but not on a chroma component.
   b. For example, the proposed method may be applied on a luma component and also on a chroma component.

### On the Granularity of Applying NN Models and Performing NN Model Selection

7. The granularity of performing NN model selection (e.g., including NN filter enabling/disabling decision, if disabled, meaning no NN model being selected) may be the same as OR different from the granularity of applying NN models, i.e. the inference block size.
   a. In one example, the granularity of applying NN models and/or the granularity of performing NN model selection may be signalled in the bitstream or derived on-the-fly.
   b. In one example, the granularity of applying NN models may be signalled in the bitstream or derived on-the-fly, and the granularity of performing NN model selection is inferred to be the same as the granularity of applying NN models.
      i. Alternatively, the granularity of performing NN model selection may be signalled in the bitstream or derived on-the-fly, and the granularity of applying NN models is inferred to be the same as the granularity of applying NN models.
   c. Alternatively, the granularity of performing NN model selection (excluding NN filter enabling/disabling decision) may be the same as OR different from the granularity of determining whether to apply NN filter or not (NN filter enabling/disabling decision).
8. The information regarding NN model selection and/or on/off control may be signalled in coding tree unit (CTU)/CTB level.
   a. In one example, for each CTU/CTB, the information of one CTU/CTB may be firstly coded before those for a next CTU/CTB.
      i. In one example, the coding order is z-scan as shown in FIG. 13 (b).
      ii. In one example, the above methods may be applied when the granularity of applying NN models is no larger than the CTU/CTB.
   b. In one example, the information of one unit is presented together with one of CTU/CTB that the unit covers.
      i. In one example, the information is presented in the first CTU/CTB that the unit covers.
      ii. In one example, the above methods may be applied when the granularity of applying NN models (denoted by unit) is larger than the CTU/CTB.
9. The information regarding NN model selection and/or on/off control may be signalled independently from the coding of CTU/CTB information.
   a. In one example, the coding of all units, if needed, may be performed together.
   b. In one example, a raster scan order as shown in FIG. 13 (a) is applied to code the information for each unit, if needed.
10. In one example, which way to code the information may be dependent on the relationship between CTU/CTB size and the granularity of applying NN models (denoted by unit).
   a. In one example, if the unit size is smaller than CTU/CTB, the coding of all units, if needed, may be performed together.
   b. In one example, if the unit size is no greater than CTU/CTB, the coding of all units within one CTU/CTB, if needed, may be performed together.
11. The information regarding NN model selection and/or on/off control may be signalled in sequence header/picture header/slice header/PPS/SPS/APS and/or together with coding tree unit (CTU) syntax.
   a. In one example, all the information regarding NN model selection and/or on/off control may be signalled in sequence header/picture header/slice header/PPS/SPS/APS.
      i. Alternatively, partial information regarding NN model selection and/or on/off control may be signalled in sequence header/picture header/slice header/PPS/SPS/APS, while the other information regarding NN model selection and/or on/off control may be signalled together with CTU syntax.
      ii. Alternatively, all the information regarding NN model selection and/or on/off control may be signalled together with CTU syntax.
      iii. In above bullets i and ii, when there are some information regarding NN model selection signalled with the CTU syntax and the granularity of performing NN model selection is smaller than the CTU size, the information regarding NN model selection may be signalled in a z-scan order together with the CTU syntax.
         1) Alternatively, the information regarding NN model selection may be signalled in a raster scan order in the CTU.
12. In one example, the information of whether to and/or how to apply NN filters may be signaled in different levels
   a. For example, the information of whether to and/or how to apply NN filters may be in a conditional way.
      i. For example, the information of whether to and/or how to apply NN filters in a first level (such as slice level) may be signaled depending on the information of whether to and/or how to apply NN filters signaled in a second level (such as sequence level or picture level), wherein the second level is higher than the first level. E.g., The information of whether to and/or how to apply NN filters may not be signaled in a first level (such as slice level) if NN filters is signaled not be used in a second level (such as sequence level or picture level).

The embodiments of the present disclosure are related to use of a NN model for coding a video. One or more neural network (NN) filter models are trained as part of an in-loop filtering technology or filtering technology used in a post-processing stage for reducing the distortion incurred during compression. Samples with different characteristics are processed by different NN filter models. The NN filter models might take information from one/multiple previously coded frames as additional input. This invention elaborates how to use information from previously coded frames, which information to use from previously coded frames, and when to use information from previously coded frames.

In the disclosure, a NN filter can be any kind of NN filter, such as a convolutional neural network (CNN) filter. In the following discussion, a NN filter may also be referred to as a non-CNN filter, e.g., filter using machine learning based solutions. In the disclosure, a NN model can be any kind of NN architectures, such as a convolutional neural network or a fully connected neural network, or a combination of convolutional neural networks and fully connected neural networks. In the following discussion, a NN filter comprises a model/structure (i.e. network topology) and parameters associated with the model/structure.

In the following discussion, a block (or video block) may be a slice, a tile, a brick, a subpicture, a coding tree unit (CTU), a coding tree block (CTB), a CTU row, a CTB row, one or multiple CUs/CBs, one ore multiple CTUs/CTBs, one or multiple virtual pipeline data units (VPDU)s, one or multiple coding units (CUs), one or multiple coding blocks (CBs), one ore multiple CTUs, one ore multiple CTBs, one or multiple Virtual Pipeline Data Units (VPDUs), a sub-region within a picture/slice/tile/brick, an inference block. In some cases, the block could be one or multiple samples/pixels.

The terms “frame” and “picture” can be used interchangeably. The terms “sample” and “pixel” can be used interchangeably.

In the following discussion, besides the additional information from reference frames, the NN filter models may take other information as input to filter the current block as well. For example, those other information could be the prediction information of current block, partitioning information of current block, boundary strengths information of current block, coding modes information of current block, etc.

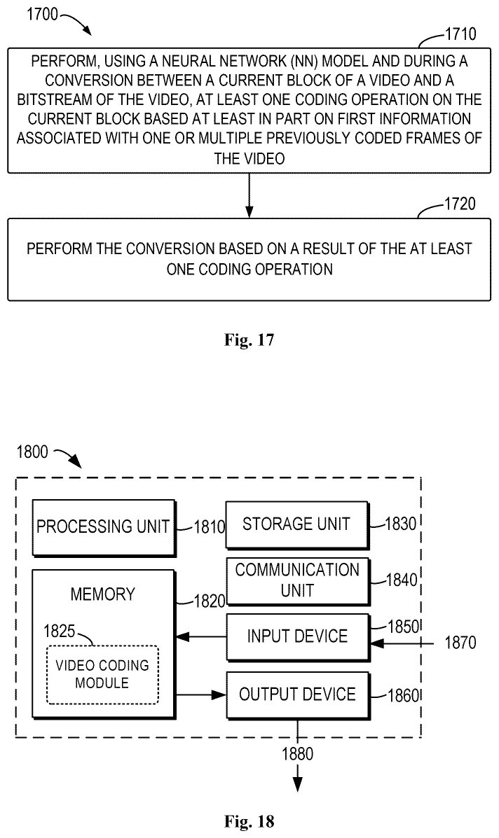

FIG. 17 illustrates a flowchart of a method 1700 for video processing in accordance with some embodiments of the present disclosure. The method 1700 may be implemented at either a video encoder or a video decoder.

At block 1710, at least one coding operation is performed, using a neural network (NN) model and during a conversion between a current block of a video and a bitstream of the video, on the current block based at least in part on first information associated with one or multiple previously coded frames of the video. The at least one coding operation comprises at least one of the following: a filtering operation, a super-resolution operation, an inter prediction operation, a virtual reference frame generation operation.

At block 1720, the conversion may be performed based on a result of the at least one coding operation. In some embodiments, the conversion includes encoding the current block into the bitstream. In some embodiments, the conversion includes decoding the current block from the bitstream.

The method 1700 enables full and efficient use of information previously coded frames to filter or process the current frame. In this way, the valuable information from multiple previously coded frames can be exploited and the coding efficiency can be improved.

In some embodiments, the at least one coding operation may comprise the filtering operation, and the performing the at least one coding operation on the current block may comprise: filtering the current block by taking the first information as an additional input to the NN model. For example, the NN model may be a NN filter, which may take information from one/multiple previously coded frames as additional inputs when filtering a block in the current slice/frame.

In some embodiments, the one or multiple previously coded frames comprise a reference frame in at least one of the following: a reference picture list (RPL) associated with the current block, a RPL associated with a current slice comprising the current block, a RPL associated with a current frame comprising the current block, a reference picture set (RPS) associated with the current block, a RPS associated with the current slice, or a RPS associated with the current frame. In one example, a previously coded frame may be a reference frame in a RPL or RPS associated with the current block, the current slice, or the current frame.

In some embodiments, the one or multiple previously coded frames comprise at least one of the following: a short-term reference frame of the current block, a short-term reference frame of the current slice, or a short-term reference frame of the current frame. In one example, a previously coded frame may be a short-term reference picture of the current block, the current slice, or the current frame.

In some embodiments, the one or multiple previously coded frames comprise at least one of the following: a long-term reference frame of the current block, a long-term reference frame of the current slice, or a long-term reference frame of the current frame. In one example, a previously coded frame may be long-term reference picture of the current block, the current slice, or the current frame.

In some embodiments, the one or multiple previously coded frames comprise a frame stored in a decoded picture buffer (DPB) that may not be a reference frame. That is, as an alternative, the previously coded frame may not be a reference frame, but it may be stored in the decoded picture buffer (DPB).

In some embodiments, at least one indicator may be signalled in the bitstream to indicate the one or multiple previously coded frames. That is, the at least one indicator may be signalled to indicate which previously coded frame(s) to use.

In some embodiments, the at least one indicator may comprise an indicator to indicate a reference picture list comprising at least one of the one or multiple previously coded frames. That is, an indicator may be signalled to indicate which reference picture list to use.

In some embodiments, the at least one indicator may be indicated in the bitstream based on at least one condition. In this alternative, the indicator indicating which previously coded frame(s) to use may be conditionally signalled.

In some embodiments, the at least one condition may comprise at least one of: the number of reference pictures included in a RPL associated with the current block, the number of reference pictures included in a RPL associated with a current slice comprising the current block, the number of reference pictures included in a RPL associated with the current frame comprising the current block, the number of reference pictures included in a RPS associated with the current block, the number of reference pictures included in a RPS associated with the current slice or the number of reference pictures included in a RPS associated with the current frame. That is, the indicator(s) may be conditionally signalled, e.g., depending on how many reference pictures may be included in the RPL/RPS.

In some embodiments, the at least one condition may comprise the number of previously decoded pictures included on a DPB. That is, the indicator(s) may be conditionally signalled, e.g., depending on how many previously decoded pictures may be included in the DPB.

In some embodiments, the method 1700 further may comprise: determining on-the-fly the one or multiple previously coded frames for the current block. That is, which frames to be utilized may be determined on-the-fly.

In some embodiments, the one or multiple previously coded frames may be determined on-the fly as one or multiple previously coded frames in a DPB. For example, the NN filter may take information from one or multiple previously coded frames in the DPB as additional input.

In some embodiments, the one or multiple previously coded frames may be determined on-the fly as one or multiple reference frames in a first reference list for the current block. The first reference list may be a reference list, list 0. For example, the NN filter may take information from one or multiple reference frames in list 0 as additional input.

In some embodiments, the one or multiple previously coded frames may be determined on-the fly as one or multiple reference frames in a second reference list for the current block. The first reference list may be a reference list, list 1. For example, the NN filter may take information from one or multiple reference frames in list 1 as addition input.

In some embodiments, the one or multiple previously coded frames may be determined on-the fly as reference frames in both the first reference lists and the second reference list. For example, the NN filter may take information from reference frames in both list 0 and list 1 as additional input.

In some embodiments, the one or multiple previously coded frames may be determined on-the fly as a reference frame closest to a current slice or a current frame comprising the current block. In one example, the NN filter may take information from the refence frame closest to the current slice/frame (e.g., with the smallest picture order count (POC) distance to the current slice/frame) as additional input.

In some embodiments, the one or multiple previously coded frames may be determined on-the fly as a reference frame with a reference index equal to K in a reference list, where a value of K may be predefined or may be determined based on reference picture information. In one example, the NN filter may take information from the refence frame with a reference index equal to K in a reference list. In an example, K=0. In one example, K may be pre-defined. In one example, K may be derived on-the-fly according to reference picture information.

In some embodiments, the one or multiple previously coded frames may be determined on-the fly as a collocated frame for the current block. In one example, the NN filter may take information from the collocated frame as additional input.

In some embodiments, the one or multiple previously coded frames may be determined on-the-fly based on decoded information. That is, which previously coded frame to be utilized may be determined by the decoded information.

In some examples, by determining the one or multiple previously coded frames based on decoded information, which frame to be utilized may be defined as the top N most-frequently used reference frames for samples within the current slice or the current frame, where N may be a positive integer, e.g., N=1.

In some embodiments, by determining the one or multiple previously coded frames based on decoded information, which frame to be utilized may be defined as the top N most-frequently used reference frames of each reference picture list, if available, for samples within the current slice or the current frame, where N may be a positive integer, e.g., N=1.

In some embodiments, by determining the one or multiple previously coded frames based on decoded information, which frame to be utilized may be defined as the frames/pictures with top N smallest picture order count (POC) distances or absolute POC distances relative to the current frame, where N may be a positive integer, e.g., N=1.

In some embodiments, whether the first information associated with the one or multiple previously coded frames may be used in the at least one coding operation depends on decoded information of at least one region of the current block. In one example, whether to take information from previously coded frames as additional input may be dependent on decoded information (e.g., coding modes/statistics/characteristics) of at least one region of the to-be-filtered block.

In some embodiments, whether the first information may be used in the at least one coding operation depends on at least one of the following: a type of a current slice comprising the current block, a type of a current frame comprising the current block, or availability of reference frames for the current block. In one example, whether to take information from previously coded frames as additional input may be dependent on the slice/picture type. In one example, whether to take the first information from the one or multiple previously coded frames as additional input may be dependent on availability of reference pictures.

In some embodiments, the first information may be used if at least one of the following may be met: the type of the current slice indicates an inter-coded slice, or the type of the current frame indicates an inter-coded frame. In one example, the first information may be only applicable to inter-coded slices/pictures (e.g., P or B slices/pictures).

In some embodiments, whether the first information may be used depends on at least one of the following: reference picture information, or picture information in a DPB. In one example, whether to take the first information from previously coded frames as additional input may be dependent on the reference picture information or the picture information in the DPB.

In some embodiments, the first information may be used if a smallest POC distance associated with the current block may not be greater than a threshold. That is, if the smallest POC distance (e.g., the smallest POC distance between reference pictures/pictures in the DPB and current picture) may be greater than a threshold, the usage of the first information may be disabled.

In some embodiments, whether and/or how the first information may be used in the at least one coding operation depend on POCs of reference frames and a POC of a current frame comprising the current block. In one example, whether to and/or how to apply the proposed method (usage of information from the one or multiple previously coded frames) may depend on the POCs of the reference frames and that of the current frames.

In some embodiments, the first information may be used if there may be at least one reference frame in a DPB with a POC greater than the POC of the current frame, and at least one reference frame in a DPB with a POC smaller than the POC of the current frame. That is, the proposed method may be enabled only when there may be at least one reference picture/picture in DPB with POC greater than the POC of current picture and at least one reference picture/picture in DPB with POC smaller than the POC of current picture.

In some embodiments, the first information may be used in different ways when a condition may be satisfied or not satisfied. That is, the proposed method may be conducted in different ways when the condition may be satisfied or not satisfied. In some embodiments, the condition may be there may be at least one reference frame in a DPB with a POC greater than the POC of the current frame, and at least one reference frame in a DPB with a POC smaller than the POC of the current frame.

In some embodiments, the first information may be used if a reference frame in a first reference list and a reference frame in a second reference list for the current block may not be the same picture. That is, if the reference picture may be list 0 and the reference picture in list 1 may be the same picture, the proposed method may be disabled.

In some embodiments, the first information may be used if there may be a reference frame in a first reference list or a reference frame in a second reference list. That is, if the reference picture in list 0 or list 1 does not exist, it may be disabled.

In some embodiments, whether the first information may be used in the at least one coding operation depends on a temporal layer index associated with the current block. In one example, whether to take the first information from the one or multiple previously coded frames as additional input may be dependent on the temporal layer index. In some embodiments, the first information may be used if the current block has a given temporal layer index. In one example, the first information may be applicable to blocks with a given temporal layer index (e.g., the highest temporal layer).

In some embodiments, the first information may be used in the at least one coding operation if the current block does not comprise a portion of samples that may be coded in a non-inter mode. In one example, if the to-be-filtered block contains a portion of samples that may be coded in non-inter mode, the NN filter will not use the first information from the one or multiple previously coded frames to filter the current block. In some embodiments, the non-inter mode may be defined as an intra mode. In some embodiments, the non-inter mode may comprise at least one of a set of coding modes consisting of: an intra mode, an intra block copy (IBC) mode, or a Palette mode. For example, the non-inter mode may be defined as a set of coding modes which includes intra/IBC/Palette modes.

In some embodiments, whether the first information may be used in the at least one coding operation depends on a distortion between the current block and a matching block for the current block. In one example, a distortion between current block and the matching block may be calculated and used to decide whether to take the first information from previously coded frames as additional input to filter the current block.

In some embodiments, whether the first information may be used in the at least one coding operation depends on a distortion between the current block and a collocated block in a previously coded frame of the video. That is, the distortion between the collocated block in a previously coded frame and current block can be used to decide whether to take information from previously coded frames as additional input to filter current block.

In some embodiments, the method 1700 further may comprise: performing motion estimation to determine the matching block from at least one previously coded frame of the video. That is, motion estimation may be first used to find a matching block from at least one previously coded frame.

In some embodiments, the first information may be used if the distortion may not be larger than a pre-defined threshold. In one example, when the distortion may be larger than a pre-defined threshold, information from previously coded frames will not be used.

To help filter the current block (or to perform other coding operation on the current block), the NN model may use additional information from previously coded frames. In some embodiments, the first information associated with the one or multiple previously coded frames may comprise reconstruction samples/motion information in the one or multiple previously coded frames.

In some embodiments, the reconstruction samples comprise at least one of: samples in at least one reference block for the current block, samples in at least one collocated block for the current block, or samples in a region pointed by a motion vector. In one example, reconstruction samples may be defined as those in the one or multiple reference blocks and/or collocated blocks of the current block. In one example, reconstruction samples may be defined as those in a region pointed by a motion vector. In some embodiments, the motion vector may be different from a decoded motion vector associated with the current block.

In some embodiments, a center of a collocated block of the at least one collocated block may be located at the same horizontal and vertical position in a previously coded frame as that of the current block in a current frame. That is, a collocated block may refer to a block whose center may be located at the same horizontal and vertical position in a previously coded frame as that of current block in the current frame.

In some embodiments, the at least one reference block may be determined by motion estimation. In one example, a reference block may be derived by motion estimation, i.e. searching from a previously coded frame to find the block that may be closest to current block with a certain measure.

In some embodiments, the motion estimation may be performed at an integer precision. In one example, the motion estimation may be performed at integer precision to avoid fractional pixel interpolation.

In some embodiments, a reference block among the at least one reference block may be determined or derived by reusing at least one motion vector included in the current block. In some embodiments, the at least one motion vector may be rounded to an integer precision to avoid fractional pixel interpolation. In some embodiments, the reference block may be located by adding an offset to the position of the current block, where the offset may be determined by the at least one motion vector. In some embodiments, the at least one motion vector points or refers to a previously coded frame comprising the reference block. In some embodiments, the at least one motion vector may be scaled to a previously coded frame comprising the reference block.

In some embodiments, at least one block of the at least one reference block and/or the at least one collocated block may be the same size as the current block. That is, reference blocks and/or collocated blocks are the same size of the current block.

In some embodiments, at least one block of the at least one reference block and/or the at least one collocated block may be larger than the current block. In one example, reference blocks and/or collocated blocks could be larger than current block.

In some embodiments, the at least one block with the same size as the current block may be determined and extended at at least one boundary to include more samples from a previously code frame. In one example, reference blocks and/or collocated blocks with the same size of current block are first found and then extended at each boundary to contain more samples from previously coded samples. In some embodiments, a size of the extended area may be indicated in the bitstream or may be derived during decoding the current block from the bitstream. In one example, the size of extended area could be signalled to the decoder or derived on-the-fly.

In some embodiments, the first information may comprise at least one of: two reference blocks for the current block with one of the two reference blocks from the first reference frame in list 0 and the other one from the first reference frame in list 1, or two collocated blocks for the current block with one of the two collocated blocks from the first reference frame in list 0 and the other one from the first reference frame in list 1. In one example, the information contains two reference blocks and/or collocated blocks of current block, with one of them from the first reference frame in list-0 and the other from the first reference frame in list-1.

To help filter or apply other coding operations on the current block, additional information from previously coded frames is fed as input of NN filter models. The additional information such as reference blocks, collocated blocks, etc. may be fed together or separately with other information such as prediction, partitioning information, etc. Regarding how to feed the information from previously coded frames into NN filter models, in some embodiments, the current block may be filtered further based on second information different from the first information, and the first and second information may be fed to the NN model together or separately.

In some embodiments, the first and second information may be organized to have the same size and concatenated together to be fed to the NN model. In one example, different kinds of information (e.g., the first and second information) may be organized with the same size (such as the width and/or height of the 2D data) and thus are concatenated together to be fed into the NN filter models.

In some embodiments, features may be extracted from the first information through a separate convolutional branch of the NN model and the extracted features may be combined with the second information or features extracted from the second information. In one example, a separate convolutional branch may first extract features from the additional information such as one or multiple reference blocks and/or collocated blocks of current block in the previously coded frames. Those extracted features may be then fused together with other input information or fused together with the features extracted from other input information.

In some embodiments, the first information may comprise at least one reference block and/or at least one collocated block for the current block in the one or multiple previously coded frames, and the at least one reference block and/or at least one collocated block have a spatial dimension different from the second information. In one example, the reference blocks and/or collocated blocks of the current block in the previously coded frames may be with different size to (e.g. larger than) other input information such as prediction, partitioning etc.

In some embodiments, the NN model has a separate convolutional branch for extracting, from the at least one reference block and/or at least one collocated block, features with the same spatial dimension as the second information. In one example, a separate convolutional branch is used to extract features that have the same spatial dimension as other input information.

In some embodiments, the current block together with at least one reference block and/or at least one collocated block in the one or multiple previously coded frames may be fed to a motion alignment branch of the NN model and an output of the motion alignment branch may be combined with the second information. In one example, the current block together with the reference blocks and/or collocated blocks are fed together into a motion alignment branch. The output of the motion alignment branch is then fused together other information.

As indicated above, in addition to the filtering operation, the above methods (usage of the information from the one or multiple previously coded frame) may be applied to other coding technologies using NN models, e.g., super-resolution, inter prediction, virtual reference frame generation, etc.

In some embodiments, the at least one coding operation may comprise the super-resolution operation, and performing the at least one coding operation on the current block may comprise: super-resolving the current block in an inter slice by taking the first information as an additional input to the NN model. In one example, a NN model is used to super-resolve a block in a inter slice. The NN model may take information from one or multiple previously coded frames as additional input.

In some embodiments, whether and/or how the first information may be used in the NN model may be indicated in the bitstream. In some embodiments, whether and/or how the first information may be used in the NN model may be indicated in at least one of: a sequence parameter set (SPS), a picture parameter set (SPS), an adaptation parameter set (APS), a slice header, a picture header, a coding tree unit (CTU), or a coding unit (CU). That is, whether to/how to apply the proposed method may be signaled from the encoder to the decoder such as in SPS/PPS/APS/slice header/picture header/CTU/CU, etc.

In some embodiments, whether and/or how the first information may be used in the NN model depends on coding information, and the coding information may at least comprise a color component, a quantization parameter (QP), a temporal layer, etc.

In some embodiments, the first information may be applied to a luma com-ponent of the current block by the NN model without be applied to a chroma component. For example, the proposed method may only be applied on a luma component, but not on a chroma component.

In some embodiments, the first information may be applied to both a luma component and a chroma component of the current block by the NN model. For example, the proposed method may be applied on a luma component and also on a chroma component.

In some embodiments, the method 1700 may further comprise: determining a first granularity of selection of the NN model for processing the video and a second granularity of applying the NN model. Accordingly, the NN model may be selected based on the first granularity and applied based on the second granularity. In some embodiments, the first granularity may be the same as or different from the second granularity. The granularity of performing NN model selection (e.g., including the NN filter enabling/disabling decision, if disabled, meaning no NN model being selected) may be the same as OR different from the granularity of applying NN models, i.e. the inference block size.

In some embodiments, at least one of the first and second granularities may be indicated in the bitstream. In one example, the granularity of applying NN models and/or the granularity of performing NN model selection may be signalled in the bitstream. In some embodiments, at least one of the first and second granularities may be derived during processing of the video. In one example, the granularity of applying NN models and/or the granularity of performing NN model selection may be derived on-the-fly.

In some embodiments, the second granularity may be indicated in the bitstream or derived during processing of the video, and the first granularity may be determined to be the same as the second granularity. For example, the granularity of applying NN models may be signalled in the bitstream or derived on-the-fly, and the granularity of performing NN model selection is inferred to be the same as the granularity of applying NN models.

In some embodiments, as an alternative, the first granularity may be indicated in the bitstream or derived during processing of the video, and the second granularity may be determined to be the same as the first granularity. For example, the granularity of performing NN model selection may be signalled in the bitstream or derived on-the-fly, and the granularity of applying NN models is inferred to be the same as the granularity of applying NN models.

In some embodiments, the first granularity may comprise a third granularity of selecting the NN model from a set of NN models and a fourth granularity of enabling usage of a NN model, and the third granularity may be the same as or different from the fourth granularity. For example, the granularity of performing NN model selection (excluding NN filter enabling/disabling decision) may be the same as OR different from the granularity of determining whether to apply the NN filter or not (NN filter enabling/disabling decision).

In some embodiments, third information regarding selecting the NN model from a set of NN models and/or whether usage of the NN model may be enabled may be indicated in the bitstream in at least one of: a level of a coding tree unit (CTU), or a level of a coding tree block (CTB). That is, the information regarding NN model selection and/or on/off control may be signalled in CTU/CTB level.

In some embodiments, the third information for a CTU may be coded before the third information for a next CTU, and/or where the third information for a CTB may be coded before the third information for a next CTB. In one example, for each CTU/CTB, the information of one CTU/CTB may be firstly coded before those for a next CTU/CTB.

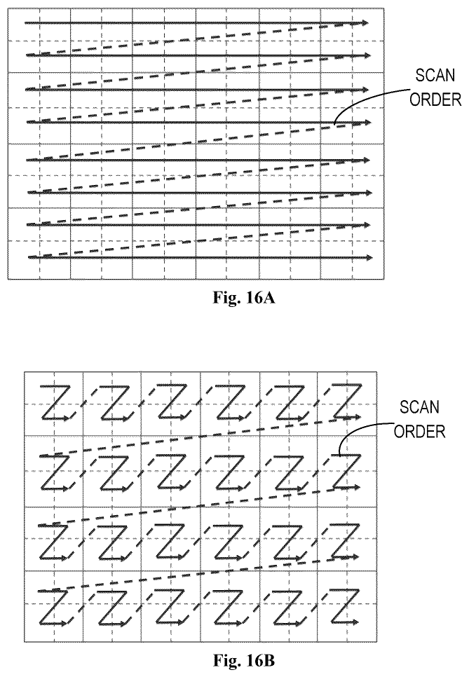

In some embodiments, a Z-scan order may be used to code the third information for the CTUs and/or CTBs. An example coding order for the Z-scan is shown in FIG. 16A. In FIG. 16A, the solid and dash blue lines represent the CTU boundary and inference block boundary respectively.

In some embodiments, the second granularity may not be larger than the CTU and/or the CTB. That is, the above methods may be applied when the granularity of applying NN models is no larger than the CTU/CTB.

In some embodiments, the third information for a unit corresponding to the second granularity may be presented together with one of CTUs and/or CTBs covered by the unit. In one example, the information of one unit is presented together with one of CTU/CTB that the unit covers. In some embodiments, the third information may be presented in the first CTU and/or the first CTB covered by the unit. In one example, the information is presented in the first CTU/CTB that the unit covers. In some embodiments, the second granularity may be larger than the CTU and/or the CTB. That is, the above methods may be applied when the granularity of applying NN models (denoted by unit) is larger than the CTU/CTB.

In some embodiments, third information regarding selecting the NN model from a set of NN models and/or whether usage of the NN model may be enabled may be indicated in the bitstream independently from coding of the CTU and/or the CTB. The information regarding NN model selection and/or on/off control may be signalled independently from the coding of CTU/CTB information.

In some embodiments, coding of the third information for units each corresponding to the second granularity may be performed together. In one example, the coding of all units, if needed, may be performed together.

In some embodiments, a raster scan order may be used to code the third information for each unit corresponding to the second granularity. An example of the raster scan order is shown in FIG. 16B. In FIG. 16B, the solid and dash blue lines represent the CTU boundary and inference block boundary respectively.

In some embodiments, a scheme to code the third information depends on a relationship between a size of the CTU and/or the CTB and a size of a unit corresponding to the second granularity. In one example, which way to code the information may be dependent on the relationship between CTU/CTB size and the granularity of applying NN models (denoted by unit).

In some embodiments, coding of the third information for the units may be performed together if sizes of the units may be smaller than a size of the CTU and/or the CTB. In one example, if the unit size is smaller than CTU/CTB, the coding of all units, if needed, may be performed together.

In some embodiments, coding of the third information for all units with-in a CTU or a CTB may be performed together if sizes of the units may not be greater than a size of the CTU and/or the CTB. In one example, if the unit size is no greater than CTU/CTB, the coding of all units within one CTU/CTB, if needed, may be performed together.

In some embodiments, fifth information regarding selecting the NN model from a set of NN models and/or whether usage of the NN model may be enabled may be indicated in at least one of: a sequence header, a picture header, a slice header, a sequence parameter set (SPS), a picture parameter set (PPS), or an adaptation parameter set (APS), and/or where the fifth information may be indicated together with coding tree unit (CTU) syntax. That is, the information regarding NN model selection and/or on/off control may be signalled in sequence header/picture header/slice header/PPS/SPS/APS and/or together with CTU syntax.

In some embodiments, all the fifth information may be indicated in at least one of: the sequence header, the picture header, the slice header, the SPS, the PPS, or the APS. In one example, all the information regarding NN model selection and/or on/off control may be signalled in sequence header/picture header/slice header/PPS/SPS/APS.

Alternatively, a part of the fifth information may be indicated in in at least one of: the sequence header, the picture header, the slice header, the SPS, the PPS, or the APS and another part of the fifth information may be indicated together with the CTU syntax. For example, partial information regarding NN model selection and/or on/off control may be signalled in sequence header/picture header/slice header/PPS/SPS/APS, while the other information regarding NN model selection and/or on/off control may be signalled together with CTU syntax.

Alternatively, all the fifth information may be indicated together with the CTU syntax. That is, all the information regarding NN model selection and/or on/off control may be signalled together with CTU syntax.

In some embodiments, if at least one part of the fifth information may be indicated together with the CTU syntax and the first granularity may be smaller than a size of the CTU, the at least one part of the fifth information may be indicated in a z-scan order together with the CTU syntax. That is, when there are some information regarding NN model selection signalled with the CTU syntax and the granularity of performing NN model selection is smaller than the CTU size, the information regarding NN model selection may be signalled in a z-scan order together with the CTU syntax.

In some embodiments, alternatively, the fifth information may be indicated in a raster scan order together with the CTU syntax. That is, the information regarding NN model selection may be signalled in a raster scan order in the CTU.

In some embodiments, sixth information regarding usage of the NN model may be indicated in the bitstream at different levels. In one example, the information of whether to and/or how to apply NN filters may be signaled in different levels.

In some embodiments, whether the sixth information at a level may be indicated depends on a condition. For example, the information of whether to and/or how to apply NN filters may be in a conditional way.

In some embodiments, whether the sixth information at a first level may be indicated depends on the sixth information at a second level higher than the first level. For example, the information of whether to and/or how to apply NN filters in a first level (such as slice level) may be signaled depending on the information of whether to and/or how to apply NN filters signaled in a second level (such as sequence level or picture level), wherein the second level is higher than the first level. E.g., The information of whether to and/or how to apply NN filters may not be signaled in a first level (such as slice level) if NN filters is signaled not be used in a second level (such as sequence level or picture level).

According to further embodiments of the present disclosure, a non-transitory computer-readable recording medium is provided. The non-transitory computer-readable recording medium stores a bitstream of a video which is generated by a method performed by an apparatus for video processing. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; and generating a bitstream of the video based on a result of the at least one coding operation.

According to still further embodiments of the present disclosure, a method for storing bitstream of a video is provided. The method comprises: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; generating a bitstream of the video based on a result of the at least one coding operation; and storing the bitstream in a non-transitory computer-readable recording medium.

Implementations of the present disclosure can be described in view of the following clauses, the features of which can be combined in any reasonable manner.

Clause 1. A method for video processing, comprising: performing, using a neural network (NN) model and during a conversion between a current block of a video and a bitstream of the video, at least one coding operation on the current block based at least in part on first information associated with one or multiple previously coded frames of the video, wherein the at least one coding operation comprises at least one of the following: a filtering operation, a super-resolution operation, an inter prediction operation, a virtual reference frame generation operation; and performing the conversion based on a result of the at least one coding operation.

Clause 2. The method of clause 1, wherein the one or multiple previously coded frames comprise a reference frame in at least one of the following: a reference picture list (RPL) associated with the current block, a RPL associated with a current slice comprising the current block, a RPL associated with a current frame comprising the current block, a reference picture set (RPS) associated with the current block, a RPS associated with the current slice, or a RPS associated with the current frame.

Clause 3. The method of clause 2, wherein the one or multiple previously coded frames comprise at least one of the following: a short-term reference frame of the current block, a short-term reference frame of the current slice, or a short-term reference frame of the current frame.

Clause 4. The method of clause 2 or 3, wherein the one or multiple previously coded frames comprise at least one of the following: a long-term reference frame of the current block, a long-term reference frame of the current slice, or a long-term reference frame of the current frame.

Clause 5. The method of any of clauses 1-4, wherein the one or multiple previously coded frames comprise a frame stored in a decoded picture buffer (DPB) that is not a reference frame.

Clause 6. The method of any of clauses 1-5, wherein at least one indicator is signalled in the bitstream to indicate the one or multiple previously coded frames.

Clause 7. The method of clause 6, wherein the at least one indicator comprises an indicator to indicate a reference picture list comprising at least one of the one or multiple previously coded frames.

Clause 8. The method of clause 6 or 7, wherein the at least one indicator is indicated in the bitstream based on at least one condition.

Clause 9. The method of clause 8, wherein the at least one condition comprises at least one of: the number of reference pictures included in a RPL associated with the current block, the number of reference pictures included in a RPL associated with a current slice comprising the current block, the number of reference pictures included in a RPL associated with the current frame comprising the current block, the number of reference pictures included in a RPS associated with the current block, the number of reference pictures included in a RPS associated with the current slice, or the number of reference pictures included in a RPS associated with the current frame, or the number of previously decoded pictures included on a DPB.

Clause 10. The method of any of clauses 1-9, further comprising: determining on-the-fly the one or multiple previously coded frames for the current block.

Clause 11. The method of clause 10, wherein determining on-the-fly the one or multiple previously coded frames comprises: determining the one or multiple previously coded frames to be at least one of the following: one or multiple previously coded frames in a DPB, one or multiple reference frames in a first reference list for the current block, one or multiple reference frames in a second reference list for the current block, reference frames in both the first reference lists and the second reference list, a reference frame closest to a current slice or a current frame comprising the current block, or a reference frame with a reference index equal to K in a reference list, wherein a value of K is predefined or is determined based on reference picture information, or a collocated frame for the current block.

Clause 12. The method of clause 10 or 11, wherein determining on-the-fly the one or multiple previously coded frames comprises: determining the one or multiple previously coded frames based on decoded information.

Clause 13. The method of clause 12, wherein determining on-the-fly the one or multiple previously coded frames based on decoded information comprises: determining the one or multiple previously coded frames as top N most-frequently used reference frames for samples within at least one of: a current slice comprising the current block, or a current frame comprising the current block, wherein N is a positive integer.

Clause 14. The method of clause 13, wherein determining on-the-fly the one or multiple previously coded frames based on decoded information comprises: determining the one or multiple previously coded frames as top N most-frequently used reference frames of each reference picture list for samples within at least one of: a current slice comprising the current block, or a current frame comprising the current block, wherein N is a positive integer.

Clause 15. The method of clause 13, wherein determining on-the-fly the one or multiple previously coded frames based on decoded information comprises: determining the one or multiple previously coded frames as frames with top N smallest picture order count (POC) distances or absolute POC distances relative to a current frame comprising the current block, wherein N is a positive integer.

Clause 16. The method of any of clauses 1-15, wherein whether the first information is used in the at least one coding operation depends on decoded information of at least one region of the current block.

Clause 17. The method of clause 16, wherein whether the first information is used in the at least one coding operation depends on at least one of the following: a type of a current slice comprising the current block, a type of a current frame comprising the current block, or availability of reference frames for the current block.

Clause 18. The method of clause 17, wherein the first information is used if at least one of the following is met: the type of the current slice indicates an inter-coded slice, or the type of the current frame indicates an inter-coded frame.

Clause 19. The method of clause 16, wherein whether the first information is used depends on at least one of the following: reference picture information, or picture information in a DPB.

Clause 20. The method of clause 19, wherein the first information is used if a smallest POC distance associated with the current block is not greater than a threshold.

Clause 21. The method of clause 19, wherein whether and/or how the first information is used in the at least one coding operation depend on POCs of reference frames and a POC of a current frame comprising the current block.

Clause 22. The method of clause 21, wherein the first information is used if there is at least one reference frame in a DPB with a POC greater than the POC of the current frame, and at least one reference frame in a DPB with a POC smaller than the POC of the current frame.

Clause 23. The method of clause 21, wherein the first information is used in different ways when a condition is satisfied or not satisfied, and wherein the condition comprises there being at least one reference frame in a DPB with a POC greater than the POC of the current frame, and at least one reference frame in a DPB with a POC smaller than the POC of the current frame.

Clause 24. The method of clause 19, wherein the first information is used if a reference frame in a first reference list and a reference frame in a second reference list for the current block are not the same picture.

Clause 25. The method of clause 19, wherein the first information is used if there is a reference frame in a first reference list or a reference frame in a second reference list.

Clause 26. The method of clause 16, wherein whether the first information is used in the at least one coding operation depends on a temporal layer index associated with the current block.

Clause 27. The method of clause 26, wherein the first information is used if the current block has a given temporal layer index.

Clause 28. The method of clause 16, wherein the first information is used in the at least one coding operation if the current block does not comprise a portion of samples that are coded in a non-inter mode.

Clause 29. The method of clause 28, wherein the non-inter mode comprises an intra mode.

Clause 30. The method of clause 28, wherein the non-inter mode comprises at least one of a set of coding modes consisting of: an intra mode, an intra block copy (IBC) mode, or a Palette mode.

Clause 31. The method of clause 16, wherein whether the first information is used in the at least one coding operation depends on at least one of: a distortion between the current block and a matching block for the current block, or a distortion between the current block and a collocated block in a previously coded frame of the video.

Clause 32. The method of clause 31, further comprising: performing motion estimation to determine the matching block from at least one previously coded frame of the video.

Clause 33. The method of clause 31, wherein the first information is used if the distortion is not larger than a pre-defined threshold.

Clause 34. The method of any of clauses 1-33, wherein the first information comprises at least one of: reconstruction samples in the one or multiple previously coded frames, or motion information in the one or multiple previously coded frames.

Clause 35. The method of clause 34, wherein the reconstruction samples comprise at least one of: samples in at least one reference block for the current block, samples in at least one collocated block for the current block, or samples in a region pointed by a motion vector.

Clause 36. The method of clause 35, wherein the motion vector is different from a decoded motion vector associated with the current block.

Clause 37. The method of clause 35, wherein a center of a collocated block of the at least one collocated block is located at the same horizontal and vertical position in a previously coded frame as that of the current block in a current frame.

Clause 38. The method of clause 35, wherein the at least one reference block is determined by motion estimation.

Clause 39. The method of clause 38, wherein the motion estimation is performed at an integer precision.

Clause 40. The method of clause 35, wherein a reference block among the at least one reference block is determined by reusing at least one motion vector included in the current block.

Clause 41. The method of clause 40, wherein the at least one motion vector is rounded to an integer precision.

Clause 42. The method of 40 or 41, wherein the reference block is located by adding an offset to the position of the current block, wherein the offset is determined by the at least one motion vector.

Clause 43. The method of any of clauses 40-42, wherein the at least one motion vector points to a previously coded frame comprising the reference block.

Clause 44. The method of any of clauses 40-43, wherein the at least one motion vector is scaled to a previously coded frame comprising the reference block.

Clause 45. The method of clause 35, wherein at least one block of the at least one reference block and/or the at least one collocated block is the same size as the current block.

Clause 46. The method of clause 35, wherein at least one block of the at least one reference block and/or the at least one collocated block is larger than the current block.

Clause 47. The method of clause 46, wherein the at least one block with the same size as the current block is determined and extended at at least one boundary to include more samples from a previously code frame.

Clause 48. The method of clause 47, wherein a size of the extended area is indicated in the bitstream or is derived during decoding the current block from the bitstream.

Clause 49. The method of any of clauses 1-48, wherein the first information comprises at least one of: two reference blocks for the current block with one of the two reference blocks from the first reference frame in list 0 and the other one from the first reference frame in list 1, or two collocated blocks for the current block with one of the two collocated blocks from the first reference frame in list 0 and the other one from the first reference frame in list 1.

Clause 50. The method of any of clauses 1-49, wherein the current block is filtered further based on second information different from the first information, and the first and second information is fed to the NN model together or separately.

Clause 51. The method of clause 50, wherein the first and second information is organized to have the same size and concatenated together to be fed to the NN model.

Clause 52. The method of clause 50, wherein features are extracted from the first information through a separate convolutional branch of the NN model and the extracted features are combined with the second information or features extracted from the second information.

Clause 53. The method of clause 52, wherein the first information comprises at least one reference block and/or at least one collocated block for the current block in the one or multiple previously coded frames, and the at least one reference block and/or at least one collocated block have a spatial dimension different from the second information.

Clause 54. The method of clause 53, wherein the NN model has a separate convolutional branch for extracting, from the at least one reference block and/or at least one collocated block, features with the same spatial dimension as the second information.

Clause 55. The method of clause 50, wherein the current block together with at least one reference block and/or at least one collocated block in the one or multiple previously coded frames are fed to a motion alignment branch of the NN model and an output of the motion alignment branch is combined with the second information.

Clause 56. The method of any of clauses 1-55, wherein the at least one coding operation comprises the filtering operation, and performing the at least one coding operation on the current block comprises: filtering the current block by taking the first information as an additional input to the NN model.

Clause 57. The method of any of clauses 1-56, wherein the at least one coding operation comprises the super-resolution operation, and performing the at least one coding operation on the current block comprises: super-resolving the current block in an inter slice by taking the first information as an additional input to the NN model.

Clause 58. The method of any of clauses 1-57, wherein whether and/or how the first information is used in the NN model is indicated in the bitstream.

Clause 59. The method of clause 58, wherein whether and/or how the first information is used in the NN model is indicated in at least one of: a sequence parameter set (SPS), a picture parameter set (SPS), an adaptation parameter set (APS), a slice header, a picture header, a coding tree unit (CTU), or a coding unit (CU).

Clause 60. The method of any of clauses 1-59, wherein whether and/or how the first information is used in the NN model depends on coding information, and wherein the coding information at least comprises a color component, a quantization parameter, or a temporal layer.

Clause 61. The method of clause 60, wherein the first information is applied to a luma com-ponent of the current block by the NN model without be applied to a chroma component.

Clause 62. The method of clause 60, wherein the first information is applied to both a luma component and a chroma component of the current block by the NN model.

Clause 63. The method of any of clauses 1 to 62, further comprising: determining a first granularity of selection of the NN model for processing the video and a second granularity of applying the NN model, and wherein the NN model is selected based on the first granularity and applied based on the second granularity.

Clause 64. The method of clause 63, wherein the first granularity is the same as or different from the second granularity.

Clause 65. The method of clause 63 or 64, wherein at least one of the first and second granularities is indicated in the bitstream, or wherein at least one of the first and second granularities is derived during processing of the video.

Clause 66. The method of any of clauses 63 to 65, wherein the second granularity is indicated in the bitstream or derived during processing of the video, and the first granularity is determined to be the same as the second granularity.

Clause 67. The method of any of clauses 63-66, wherein the first granularity is indicated in the bitstream or derived during processing of the video, and the second granularity is determined to be the same as the first granularity.

Clause 68. The method of any of clauses 63-67, wherein the first granularity comprises a third granularity of selecting the NN model from a set of NN models and a fourth granularity of enabling usage of a NN model, and the third granularity is the same as or different from the fourth granularity.

Clause 69. The method of any of clauses 63-68, wherein third information regarding selecting the NN model from a set of NN models and/or whether usage of the NN model is enabled is indicated in the bitstream in at least one of: a level of a coding tree unit (CTU), or a level of a coding tree block (CTB).

Clause 70. The method of clause 69, wherein the third information for a CTU is coded before the third information for a next CTU, and/or wherein the third information for a CTB is coded before the third information for a next CTB.

Clause 71. The method of clause 70, wherein a Z-scan order is used to code the third information for the CTUs and/or CTBs.

Clause 72. The method of any of clauses 70-71, wherein the second granularity is not larger than the CTU and/or the CTB.

Clause 73. The method of clause 69, wherein the third information for a unit corresponding to the second granularity is presented together with one of CTUs and/or CTBs covered by the unit.

Clause 74. The method of clause 73, wherein the third information is presented in the first CTU and/or the first CTB covered by the unit.

Clause 75. The method of any of clauses 73-74, wherein the second granularity is larger than the CTU and/or the CTB.

Clause 76. The method of any of clauses 63-75, wherein third information regarding selecting the NN model from a set of NN models and/or whether usage of the NN model is enabled is indicated in the bitstream independently from coding of the CTU and/or the CTB.

Clause 77. The method of clause 76, wherein coding of the third information for units each corresponding to the second granularity is performed together.

Clause 78. The method of any of clauses 76-77, wherein a raster scan order is used to code the third information for each unit corresponding to the second granularity.

Clause 79. The method of any of clauses 69-78, wherein a scheme to code the third information depends on a relationship between a size of the CTU and/or the CTB and a size of a unit corresponding to the second granularity.

Clause 80. The method of clause 79, wherein coding of the third information for the units is performed together if sizes of the units are smaller than a size of the CTU and/or the CTB.

Clause 81. The method of clause 79, wherein coding of the third information for all units with-in a CTU or a CTB is performed together if sizes of the units are not greater than a size of the CTU and/or the CTB.

Clause 82. The method of any of clauses 63-81, wherein fifth information regarding selecting the NN model from a set of NN models and/or whether usage of the NN model is enabled is indicated in at least one of: a sequence header, a picture header, a slice header, a sequence parameter set (SPS), a picture parameter set (PPS), or an adaptation parameter set (APS), and/or wherein the fifth information is indicated together with coding tree unit (CTU) syntax.

Clause 83. The method of clause 82, wherein all the fifth information is indicated in at least one of: the sequence header, the picture header, the slice header, the SPS, the PPS, or the APS.

Clause 84. The method of clause 82, wherein a part of the fifth information is indicated in in at least one of: the sequence header, the picture header, the slice header, the SPS, the PPS, or the APS and another part of the fifth information is indicated together with the CTU syntax.

Clause 85. The method of clause 82, wherein all the fifth information is indicated together with the CTU syntax.

Clause 86. The method of any of clauses 82-85, wherein if at least one part of the fifth information is indicated together with the CTU syntax and the first granularity is smaller than a size of the CTU, the at least one part of the fifth information is indicated in a z-scan order together with the CTU syntax.

Clause 87. The method of any of clauses 82-85, wherein the fifth information is indicated in a raster scan order together with the CTU syntax.

Clause 88. The method of any of clauses 63-87, wherein sixth information regarding usage of the NN model is indicated in the bitstream at different levels.

Clause 89. The method of clause 88, wherein whether the sixth information at a level is indicated depends on a condition.

Clause 90. The method of any of clauses 88-89, wherein whether the sixth information at a first level is indicated depends on the sixth information at a second level higher than the first level.

Clause 91. The method of any of clauses 1-90, wherein the conversion includes encoding the current block into the bitstream, or wherein the conversion includes decoding the current block from the bitstream.

Clause 92. An apparatus for processing video data comprising a processor and a non-transitory memory with instructions thereon, wherein the instructions upon execution by the processor, cause the processor to perform a method in accordance with any of clauses 1-91.

Clause 93. A non-transitory computer-readable storage medium storing instructions that cause a processor to perform a method in accordance with any of clauses 1-91.

Clause 94. A non-transitory computer-readable recording medium storing a bitstream of a video which is generated by a method performed by a video processing apparatus, wherein the method comprises: performing, using a neural network (NN) model, at least one coding operation on a current block of the video based at least in part on first information associated with one or multiple previously coded frames of the video, wherein the at least one coding operation comprises at least one of the following: a filtering operation, a super-resolution operation, an inter prediction operation, a virtual reference frame generation operation; and generating a bitstream of the video based on a result of the at least one coding operation.

Clause 95. A method for storing a bitstream of a video, comprising: performing, using a neural network (NN) model, at least one coding operation on a current block of the video based at least in part on first information associated with one or multiple previously coded frames of the video, wherein the at least one coding operation comprises at least one of the following: a filtering operation, a super-resolution operation, an inter prediction operation, a virtual reference frame generation operation; generating a bitstream of the video based on a result of the at least one coding operation; and storing the bitstream in a non-transitory computer-readable recording medium.

### Example Device

FIG. 18 illustrates a block diagram of a computing device 1800 in which various embodiments of the present disclosure can be implemented. The computing device 1800 may be implemented as or included in the source device 110 (or the video encoder 114 or 200) or the destination device 120 (or the video decoder 124 or 300).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement video encoding/decoding in embodiments of the present disclosure. The memory 1820 may include one or more video coding modules 1825 having one or more program instructions. These modules are accessible and executable by the processing unit 1810 to perform the functionalities of the various embodiments described herein.

In the example embodiments of performing video encoding, the input device 1850 may receive video data as an input 1870 to be encoded. The video data may be processed, for example, by the video coding module 1825, to generate an encoded bitstream. The encoded bitstream may be provided via the output device 1860 as an output 1880.

In the example embodiments of performing video decoding, the input device 1850 may receive an encoded bitstream as the input 1870. The encoded bitstream may be processed, for example, by the video coding module 1825, to generate decoded video data. The decoded video data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing, using a neural network (NN) model and during a conversion between a current block of a video and a bitstream of the video, at least one coding operation on the current block based at least in part on first information associated with one or multiple previously coded frames of the video,
wherein the at least one coding operation comprises at least one of the following: a filtering operation, a super-resolution operation, an inter prediction operation, a virtual reference frame generation operation; and
performing the conversion based on a result of the at least one coding operation.

2. The method of claim 1, wherein the one or multiple previously coded frames comprise a reference frame in at least one of the following: a reference picture list (RPL) associated with the current block, a RPL associated with a current slice comprising the current block, a RPL associated with a current frame comprising the current block, a reference picture set (RPS) associated with the current block, a RPS associated with the current slice, or a RPS associated with the current frame, or
wherein the one or multiple previously coded frames comprise a frame stored in a decoded picture buffer (DPB) that is not a reference frame, or
wherein at least one indicator is signalled in the bitstream to indicate the one or multiple previously coded frames, or
wherein the one or multiple previously coded frames for the current block is determined on-the-fly.

3. The method of claim 1, wherein whether the first information is used in the at least one coding operation depends on decoded information of at least one region of the current block.

4. The method of claim 3, wherein whether the first information is used in the at least one coding operation depends on at least one of the following: a type of a current slice comprising the current block, a type of a current frame comprising the current block, or availability of reference frames for the current block, or
wherein whether the first information is used depends on at least one of the following: reference picture information, or picture information in a DPB, or
wherein whether the first information is used in the at least one coding operation depends on a temporal layer index associated with the current block, or
wherein the first information is used in the at least one coding operation if the current block does not comprise a portion of samples that are coded in a non-inter mode, or
wherein whether the first information is used in the at least one coding operation depends on at least one of: a distortion between the current block and a matching block for the current block, or a distortion between the current block and a collocated block in a previously coded frame of the video.

5. The method of claim 1, wherein the first information comprises at least one of:
reconstruction samples in the one or multiple previously coded frames, or
motion information in the one or multiple previously coded frames.

6. The method of claim 5, wherein the reconstruction samples comprise at least one of:
samples in at least one reference block for the current block,
samples in at least one collocated block for the current block, or
samples in a region pointed by a motion vector.

7. The method of claim 6, wherein the motion vector is different from a decoded motion vector associated with the current block, or
wherein a center of a collocated block of the at least one collocated block is located at the same horizontal and vertical position in a previously coded frame as that of the current block in a current frame, or
wherein the at least one reference block is determined by motion estimation, or
wherein a reference block among the at least one reference block is determined by reusing at least one motion vector included in the current block, or
wherein at least one block of the at least one reference block and/or the at least one collocated block is the same size as the current block, or
wherein at least one block of the at least one reference block and/or the at least one collocated block is larger than the current block.

8. The method of claim 1, wherein the first information comprises at least one of:
two reference blocks for the current block with one of the two reference blocks from the first reference frame in list 0 and the other one from the first reference frame in list 1, or
two collocated blocks for the current block with one of the two collocated blocks from the first reference frame in list 0 and the other one from the first reference frame in list 1.

9. The method of claim 1, wherein the current block is filtered further based on second information different from the first information, and the first and second information is fed to the NN model together or separately.

10. The method of claim 9, wherein the first and second information is organized to have the same size and concatenated together to be fed to the NN model, or
wherein features are extracted from the first information through a separate convolutional branch of the NN model and the extracted features are combined with the second information or features extracted from the second information, or
wherein the current block together with at least one reference block and/or at least one collocated block in the one or multiple previously coded frames are fed to a motion alignment branch of the NN model and an output of the motion alignment branch is combined with the second information.

11. The method of claim 1, wherein the at least one coding operation comprises the filtering operation, and performing the at least one coding operation on the current block comprises: filtering the current block by taking the first information as an additional input to the NN model, or
wherein the at least one coding operation comprises the super-resolution operation, and performing the at least one coding operation on the current block comprises: super-resolving the current block in an inter slice by taking the first information as an additional input to the NN model, or
wherein whether and/or how the first information is used in the NN model is indicated in the bitstream, or
wherein whether and/or how the first information is used in the NN model depends on coding information, and the coding information at least comprises a color component, a quantization parameter, or a temporal layer.

12. The method of claim 1, further comprising:
determining a first granularity of selection of the NN model for processing the video and a second granularity of applying the NN model, and
wherein the NN model is selected based on the first granularity and applied based on the second granularity.

13. The method of claim 12, wherein the first granularity is the same as or different from the second granularity, or
wherein at least one of the first and second granularities is indicated in the bitstream, or
wherein at least one of the first and second granularities is derived during processing of the video, or
wherein the second granularity is indicated in the bitstream or derived during processing of the video, and the first granularity is determined to be the same as the second granularity, or
wherein the first granularity is indicated in the bitstream or derived during processing of the video, and the second granularity is determined to be the same as the first granularity, or
wherein the first granularity comprises a third granularity of selecting the NN model from a set of NN models and a fourth granularity of enabling usage of a NN model, and the third granularity is the same as or different from the fourth granularity.

14. The method of claim 12, wherein third information regarding selecting the NN model from a set of NN models and/or whether usage of the NN model is enabled is indicated in the bitstream in at least one of: a level of a coding tree unit (CTU), or a level of a coding tree block (CTB), or
wherein third information regarding selecting the NN model from a set of NN models and/or whether usage of the NN model is enabled is indicated in the bitstream independently from coding of the CTU and/or the CTB.

15. The method of claim 14, wherein a scheme to code the third information depends on a relationship between a size of the CTU and/or the CTB and a size of a unit corresponding to the second granularity.

16. The method of claim 12, wherein fifth information regarding selecting the NN model from a set of NN models and/or whether usage of the NN model is enabled is indicated in at least one of: a sequence header, a picture header, a slice header, a sequence parameter set (SPS), a picture parameter set (PPS), or an adaptation parameter set (APS), and/or
wherein the fifth information is indicated together with coding tree unit (CTU) syntax, and/or
wherein sixth information regarding usage of the NN model is indicated in the bitstream at different levels.

17. The method of claim 1, wherein the conversion includes encoding the current block into the bitstream, or
wherein the conversion includes decoding the current block from the bitstream.

18. An apparatus for processing video data comprising a processor and a non-transitory memory with instructions thereon, wherein the instructions upon execution by the processor, cause the processor to perform acts comprising:
performing, using a neural network (NN) model and during a conversion between a current block of a video and a bitstream of the video, at least one coding operation on the current block based at least in part on first information associated with one or multiple previously coded frames of the video,
wherein the at least one coding operation comprises at least one of the following: a filtering operation, a super-resolution operation, an inter prediction operation, a virtual reference frame generation operation; and
performing the conversion based on a result of the at least one coding operation.

19. A non-transitory computer-readable storage medium storing instructions that cause a processor to perform acts comprising:
performing, using a neural network (NN) model and during a conversion between a current block of a video and a bitstream of the video, at least one coding operation on the current block based at least in part on first information associated with one or multiple previously coded frames of the video,
wherein the at least one coding operation comprises at least one of the following: a filtering operation, a super-resolution operation, an inter prediction operation, a virtual reference frame generation operation; and
performing the conversion based on a result of the at least one coding operation.

20. A non-transitory computer-readable recording medium storing a bitstream of a video which is generated by a method performed by a video processing apparatus, wherein the method comprises:
performing, using a neural network (NN) model, at least one coding operation on a current block of the video based at least in part on first information associated with one or multiple previously coded frames of the video,
wherein the at least one coding operation comprises at least one of the following: a filtering operation, a super-resolution operation, an inter prediction operation, a virtual reference frame generation operation; and
generating a bitstream of the video based on a result of the at least one coding operation.
